(19) United States
(12) Patent Application Publication
(10) Pub. No.: US 2026/0121804 A1
(43) Pub. Date: Apr. 30, 2026

(54) METHOD FOR WIRELESS COMMUNICATION, AND DEVICE

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 19/005,438

(22) Filed: Dec. 30, 2024

Related U.S. Application Data
(63) Continuation of application No. PCT/CN2022/110365, filed on Aug. 4, 2022.

(51) Int. Cl. H04L 5/00; H04W 76/28

(52) U.S. Cl. CPC H04L 5/0044; H04W 76/28

(57) ABSTRACT

Provided is a method for wireless communication. The method is applicable to a terminal device, and the method includes: receiving first configuration information from a network-side device; and acquiring a first duration based on the first configuration information, wherein the first duration is not configured for transmission of a first channel or signal of a first cell.

### CROSS-REFERENCE TO RELATED APPLICATION

This application is a continuation of International Application No. PCT/CN2022/110365, filed Aug. 4, 2022, the entire disclosure of which is incorporated herein by reference.

### TECHNICAL FIELD

The present disclosure relates to the technical field of wireless communication, and in particular, relates to methods and apparatuses for wireless communication, and devices, a storage medium and a program product thereof.

### BACKGROUND

With the continuous development of wireless communications technologies, energy consumption of devices in a wireless communication network is becoming increasingly higher, and network energy saving is becoming increasingly significant.

### SUMMARY

Embodiments of the present disclosure provide a method for wireless communication, and devices. The technical solutions are as follows.

According to some embodiments of the present disclosure, the embodiments of the present disclosure provide a method for wireless communication. The method is applicable to a terminal device, and the method includes:
receiving first configuration information from a network-side device; and
acquiring a first duration based on the first configuration information, wherein the first duration is not configured for transmission of a first channel or signal of a first cell.

According to some embodiments of the present disclosure, the embodiments of the present disclosure provide a terminal device. The terminal device includes a processor, a memory, and a transceiver.

The transceiver and the processor are configured to perform the above method for wireless communication.

According to some embodiments of the present disclosure, the embodiments of the present disclosure provide a network-side device. The network-side device includes a processor, a memory, and a transceiver.

The transceiver is configured to perform: transmitting first configuration information to a terminal device, wherein the first configuration information is used for the terminal device to acquire a first duration, wherein the first duration is not configured for transmission of a first channel or signal of a first cell.

### BRIEF DESCRIPTION OF THE DRAWINGS

FIG. 1 is a schematic diagram of an architecture of a communication system according to some embodiments of the present disclosure;

FIG. 2 is a diagram of a transmission example according to some exemplary embodiments of the present disclosure;

FIG. 3 is a diagram of another transmission example according to some exemplary embodiments of the present disclosure;

FIG. 4 is a flowchart of a method for wireless communication according to some embodiments of the present disclosure;

FIG. 5 is a flowchart of a method for wireless communication according to some embodiments of the present disclosure;

FIG. 6 is a schematic diagram of a wireless communication flow according to some embodiments of the present disclosure;

FIG. 7 is a flowchart of a method for wireless communication according to some embodiments of the present disclosure;

FIG. 8 is a schematic diagram of a time domain of a first period and a second period according to the embodiments shown in FIG. 7;

FIG. 9 is a schematic diagram illustrating an indication mode of fourth configuration information according to the embodiments shown in FIG. 7;

FIG. 10 is a schematic diagram illustrating an indication mode of first configuration information according to the embodiments shown in FIG. 7;

FIG. 11 is a block diagram of an apparatus for wireless communication according to some embodiments of the present disclosure;

FIG. 12 is a block diagram of an apparatus for wireless communication according to some embodiments of the present disclosure; and

FIG. 13 is a schematic structural diagram of a computer device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios described in the embodiments of the present disclosure are intended to describe the technical solutions according to the embodiments of the present disclosure more clearly, but do not constitute limitations on the technical solutions according to the embodiments of the present disclosure. Those of ordinary skill in the art understand that, with the evolution of the network architecture and the emergence of new service scenarios, the technical solutions according to the embodiments of the present disclosure are also applicable to similar technical problems.

The technical solutions of the embodiments of the present disclosure are applicable to various communication systems, such as a global system of mobile communication (GSM) system, a code-division multiple access (CDMA) system, a wideband code-division multiple access (WCDMA) system, a general packet radio service (GPRS) system, a long-term evolution (LTE) system, an advanced long-term evolution (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, an Internet of things (IoT) system, a wireless fidelity (Wi-Fi) system, a 5^{th} generation (5G) system, or other communication systems.

Generally, a conventional communication system supports a limited number of connections and is easy to implement. However, with the development of communication technologies, a mobile communication system supports not only conventional communications, but also other communications, such as device-to-device (D2D) communications, machine-to-machine (M2M) communications, machine-type communications (MTCs), vehicle-to-vehicle (V2V) communications, or vehicle-to-everything (V2X) communications. The embodiments of the present disclosure are also applicable to these communication systems.

In some embodiments, the communication systems in the embodiments of the present disclosure are applicable to a carrier aggregation (CA) scenario, a dual connectivity (DC) scenario, and a standalone (SA) networking scenario.

In some embodiments, the communication systems in the embodiments of the present disclosure are applicable to an unlicensed spectrum, wherein the unlicensed spectrum is considered as a shared spectrum; or the communication systems in the embodiments of the present disclosure are also applicable to a licensed spectrum, wherein the licensed spectrum is considered as an unshared spectrum.

In some embodiments, the communication systems in the embodiments of the present disclosure are applicable to an FR1 frequency band (corresponding to a frequency range of 410 MHz to 7.125 GHz), an FR2-1 frequency band (corresponding to a frequency range of 24.25 GHz to 52.6 GHz), and an FR2-2 frequency band (corresponding to a frequency range of 52.6 GHz to 71 GHz) or new frequency bands, such as a high-frequency band corresponding to a frequency range of 71 GHz to 114.25 GHz.

The embodiments of the present disclosure are applicable to a terrestrial network (TN) system, and to a non-terrestrial network (NTN) system.

The embodiments of the present disclosure are described in conjunction with a network-side device and a terminal device. The terminal device may also be referred to as a user equipment (UE), an access terminal, a subscriber unit, a subscriber station, a rover station, a mobile station, a remote station, a remote terminal, a mobile device, a user terminal, a terminal, a wireless communication device, a user agent, a user apparatus, or the like.

The terminal device may be a station (ST) in WLAN, or a cellular phone, a cordless phone, a Session Initiation Protocol (SIP) phone, a wireless local loop (WLL) station, a personal digital assistant (PDA) device, a handheld device with a wireless communication function, a computing device, or another processing device connected to a wireless modem, a vehicle-mounted device, a wearable device, a terminal device in a next generation communication system, such as a terminal device in an NR network, or a terminal device in an evolved public land mobile network (PLMN), or the like.

In the embodiments of the present disclosure, the terminal device may be deployed on land, for example, indoors or outdoors, handheld, wearable or vehicle-mounted; or deployed on water (for example, a ship); or deployed in the air (for example, an airplane, a balloon, or a satellite).

In the embodiments of the present disclosure, the terminal device may be a mobile phone, a tablet computer (pad), a computer with a wireless transceiver function, a virtual reality (VR) terminal device, an augmented reality (AR) terminal device, a wireless terminal device in industrial control, a wireless terminal device in self-driving, a wireless terminal device in a remote medical system, a wireless terminal device in smart grid, a wireless terminal device in transportation safety, a wireless terminal device in smart city, or a wireless terminal device in smart home. The terminal device according to the embodiments of the present disclosure may also be referred to as a terminal, a UE, an access terminal device, a vehicle-mounted terminal, an industrial control terminal, a UE unit, a UE station, a rover station, a mobile station, a remote station, a remote terminal device, a mobile device, a UE terminal device, a wireless communication device, a UE agent, or a UE apparatus. The terminal device may also be stationary or mobile.

By way of example but not limitation, in the embodiments of the present disclosure, the terminal device may be a wearable device. The wearable device is also referred to as a wearable smart device, and is a generic name of wearable devices such as glasses, gloves, watches, clothing, and shoes, which are intelligently designed and developed for daily wear using wearable technology. The wearable device is a portable device that is either worn directly on the body or integrated into the clothing or accessories of the user. The wearable device is not just a hardware device, but also implements powerful functions by software support, data interaction, and cloud interaction. The wearable smart device in a broad sense includes devices such as smart watches or smart glasses that have full functionality and larger sizes, and are capable of implementing all or part of functionality independently of smart phones, such as smart watches or smart glasses. The wearable smart device such as various smart bands and smart jewelries for monitoring physical signs, which are dedicated to a specific type of application functions and need to be used in conjunction with other devices like smart phones.

In the embodiments of the present disclosure, the network-side device may be a device for communicating with a mobile device. The network-side device may be an access point (AP) in a WLAN, a base transceiver station (BTS) in GSM or CDMA, a NodeB (NB) in WCDMA, an evolved NodeB (eNB, or eNodeB) in LTE, a relay station or an AP, a vehicle-mounted device, a wearable device, a network-side device (gNB) in an NR network, a network-side device in an evolved PLMN network, a network-side device in an NTN network, or the like.

By way of example but not limitation, in the embodiments of the present disclosure, the network-side device may be mobile. For example, the network-side device is a mobile device. In some embodiments, the network-side device is a satellite, or a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. In some embodiments, the network-side device is also a base station deployed on land, in water, or the like.

In the embodiments of the present disclosure, the network-side device may provide a service for a cell, and a terminal device communicates with the network-side device over a transmission resource (e.g., a frequency domain resource or a frequency spectrum resource) used in the cell. The cell corresponds to the network-side device (e.g., a base station), and the cell may belong to a macro base station or to a base station corresponding to a small cell. The small cell includes a metro cell, a micro cell, a pico cell, a femto cell, or the like. The small cells have the characteristics of small coverage and low transmit power, and are suitable for providing high-rate data transmission services.

The 5G system, also referred to as an NR system, may include a terrestrial network (TN) and/or a non-terrestrial network (NTN). The NTN generally provides communication services for terrestrial users by satellite communications. At present, an NTN system includes an NR-NTN system and an IoT-NTN system.

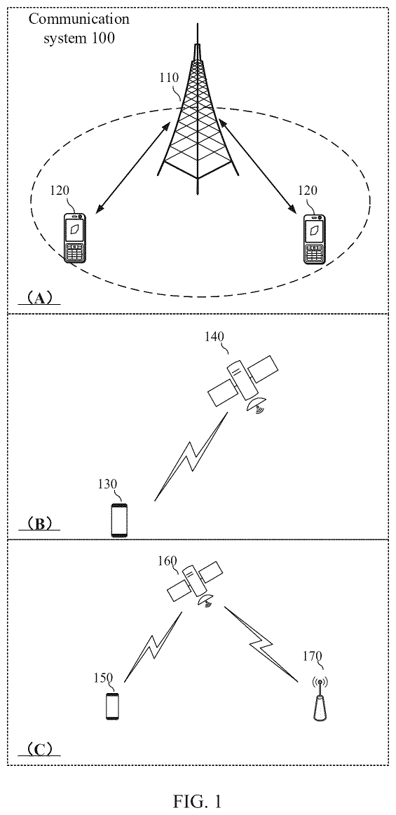

Exemplarily, FIG. 1 is a schematic diagram of an architecture of a communication system 100 according to some exemplary embodiments of the present disclosure. As shown in part (A) of FIG. 1, the communication system 100 includes a network-side device 110. The network-side device 110 communicates with terminal devices 120 (or referred to as communication terminals, or terminals). The network-side device 110 provides communication coverage to a specific geographical area, and communicates with terminal devices 120 deployed in the coverage area.

Part (A) of FIG. 1 exemplarily illustrates one network-side device 110 and two terminal devices 120. In some embodiments of the present disclosure, the communication system 100 includes a plurality of network-side devices, wherein each of the network-side devices covers other numbers of terminal devices, which is not limited in the embodiments of the present disclosure.

Exemplarily, the communication system shown in part (B) of FIG. 1 includes a terminal device 130 and a satellite 140, and wireless communication is conducted between the terminal device 130 and the satellite 140. The network formed between the terminal device 130 and the satellite 140 may also be referred to as an NTN. In the communication system shown in part (B) of FIG. 1, the satellite 140 functions as a base station, and communication is conducted directly between the terminal device 130 and the satellite 140. In the system, the satellite 140 may be referred to as a network-side device. In some embodiments of the present disclosure, the communication system further includes a plurality of satellites 140, wherein each of the satellites 140 covers other numbers of terminal devices, which is not limited in the embodiments of the present disclosure.

Exemplarily, the communication system shown in part (C) of FIG. 1 includes a terminal device 150, a satellite 160, and a base station 170, wireless communication is conducted between the terminal device 150 and the satellite 160, and communication is conducted between the satellite 160 and the base station 170. The network formed by the terminal device 150, the satellite 160, and the base station 170 may also be referred to as an NTN. In the communication system shown in part (C) of FIG. 1, the satellite 160 does not function as a base station, and communication between the terminal device 150 and the base station 170 needs to be relayed over the satellite 160. In the system architecture, the base station 170 may be referred to as a network-side device. In some embodiments of the present disclosure, the communication system includes a plurality of base stations 170, wherein each of the base stations 170 (i.e., a signal coverage of the corresponding satellite 160) covers other numbers of terminal devices, which is not limited in the embodiments of the present disclosure.

It should be noted that parts (A)-(C) in FIG. 1 illustrate systems to which the present disclosure is applicable by way of example only. Additionally, the methods according to the embodiments of the present disclosure are applicable to other systems, which is not specifically limited in the embodiments of the present disclosure.

In some embodiments, the wireless communication system shown in parts (A)-(C) in FIG. 1 further includes other network entities, such as a mobility management entity (MME) and an access and mobility management function (AMF), which is not limited in the embodiments of the present disclosure.

It should be understood that a device having a communication function in the network/system according to the embodiments of the present disclosure may be referred to as a communication device. Using the communication system 100 shown in part (A) of FIG. 1 as an example, the communication device includes a network-side device 110 and a terminal device 120 that have a communication function, and the network-side device 110 and the terminal device 120 are devices that have been specifically described above, which are not described herein any further. The communication device further includes other devices in the communication system 100, such as a network controller, a mobility management entity, or other network entities, which is not limited in the embodiments of the present disclosure.

It should be understood that the terms “system” and “network” herein are often used interchangeably. The term “and/or” herein is merely a way to describe an association relationship between associated objects, and indicates that three types of relationships may exist. For example, the phrase “A and/or B” means (A), (B), or (A and B). In addition, the symbol “/” herein generally indicates an “or”relationship between the associated objects before and after the “/”.

It should be understood that the term “indication” as mentioned in the embodiments of the present disclosure is a direct indication, an indirect indication, or an indication of an association relationship. For example, “A indicates B” may mean that A indicates B directly, e.g., B may be acquired through A; or that A indicates B indirectly, e.g., A indicates C through which B may be acquired; or that an association relationship is present between A and B.

In the embodiments of the present disclosure, the term “configuration” may be implemented by transmitting indication information from the network-side device to the terminal device.

In the description of the embodiments of the present disclosure, the term “correspond” indicates a direct or indirect corresponding relationship between two items, or indicates an association relationship between the two. It may also indicate relationships such as indicating and being indicated, configuring and being configured, or the like.

In the embodiments of the present disclosure, the term “predefined” or “preconfigured” may be implemented by pre-storing corresponding codes, tables, or other means for indicating relevant information in the devices (e.g., including terminal devices and network-side devices), which is not specifically limited in the present disclosure. For example, the term “predefined” may refer to being defined in a protocol.

In the embodiments of the present disclosure, the term “protocol” may refer to a standard protocol in the field of communications, and for example, may include an LTE protocol, an NR protocol, and related protocols applicable to future communication systems, which is not limited in the present disclosure.

Network energy saving is of great significance to environmental sustainability, environmental impact reduction (greenhouse gas emission reduction), operational expenditure saving, and the like. With the increasing popularity of 5G in various industries and geographic regions, it is necessary to support very high data transmission rates to handle more advanced services and applications. As a result, network deployments become denser and use more antennas, larger bandwidths, and more frequency bands. Considering the impact of 5G on the environment, it is necessary to develop controlled and new solutions to enhance the effect of network energy saving.

Energy consumption has become a critical part of the operator's operational expenditure (OPEX). Relevant research has shown that the energy cost of a mobile network accounts for approximately 23% of the total operational expenditure. Most of the energy consumption comes from a radio access network, more specifically, from an active antenna unit (AAU), wherein the data center and the fiber optic transmission account for a smaller share. The power consumption of a single radio access is divided into two parts. The dynamic part includes only power consumption in the case that data is being transmitted or received; and the static part includes power consumption at all times to maintain the necessary operation of the radio access device, including power consumption in the case that no data is being transmitted or received.

In the related art, network energy saving may be generally achieved by configuring a mode of discontinuous reception (DRX) for a terminal device. That is, a network-side device configures the DRX for the terminal, which enables the terminal device to monitor a downlink control channel and receive and transmit a portion of channels or signals in an active time in the DRX. In this way, energy consumption of the terminal device is reduced to some extent, such that network energy saving is achieved.

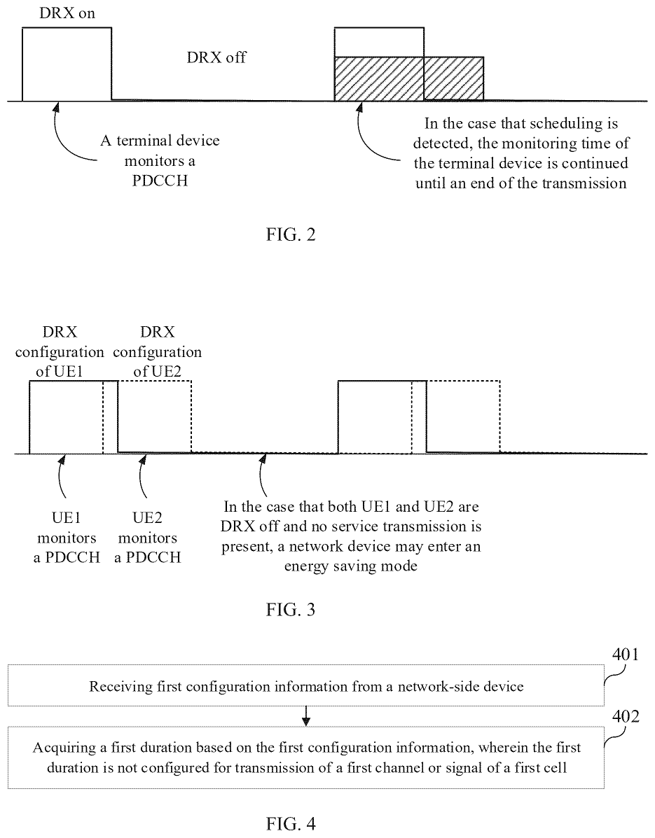

In the solutions according to the present disclosure, one network energy saving technology is to configure a DRX mode for the terminal device. Referring to FIG. 2, a diagram of a transmission example according to some exemplary embodiments of the present disclosure is shown. As shown in FIG. 2, in the case that the terminal device is in the DRX operation mode, generally, the terminal device only needs to monitor a physical downlink control channel (PDCCH) of a specific radio network temporary identifier (RNTI) scrambling code in a DRX on duration, and perform corresponding downlink data reception and/or uplink data transmission based on PDCCH scheduling in the case that the PDCCH is detected. In the case of no traffic transmission requirement, the monitoring of the PDCCH of the specific RNTI scrambling code is not performed in a DRX off duration. Accordingly, in the case of no service transmission requirement, the network-side device does not need to perform PDCCH scheduling of the specific RNTI scrambling code for the terminal device in the DRX off duration. Therefore, the energy consumption of the terminal device and the network-side device may be reduced to some extent.

In the above solutions, the network-side device may configure the DRX mode for each terminal device independently, and thus DRX configuration parameters (for example, a start time of the DRX on and/or the DRX on duration) of each terminal device may be different. In this case, as a plurality of terminal devices are generally deployed in a cell, in the case that some of the terminal devices are in the DRX off duration, other terminal devices may be in the DRX on duration. Referring to FIG. 3, a diagram of another transmission example according to some exemplary embodiments of the present disclosure is shown. As shown in FIG. 3, it is assumed that two terminal devices, UE1 and UE2, are deployed in the network, and DRX configurations of the two terminal devices are different. As the network-side device needs to prepare for scheduling for different terminal devices, the network-side device enters a specific energy saving mode (e.g., a deep sleep mode) only in the case that all terminal devices in the network are in the DRX off duration and no service transmission is present (i.e., UE1 and UE2 in FIG. 3 are in the DRX off duration and no service transmission is present). As such, the time that the network-side device can be in the specific energy saving mode is not long. Therefore, although the terminal device may benefit from the DRX mode configuration to achieve the energy saving effect, the energy saving effect of the network-side device is not significant in this case. Therefore, how to enable the network-side device and the communication network to achieve a better energy saving effect is a problem to be solved in the field of mobile communications.

The solutions according to the subsequent embodiments of the present disclosure provide a solution for configuring wireless communication of the terminal device based on considerations of energy saving of the network-side device and the communication network.

Referring to FIG. 4, a flowchart of a method for wireless communication according to some embodiments of the present disclosure is shown. The method is applicable to a terminal device, and the terminal device may be the terminal device 120, the terminal device 130, or the terminal device 150 in the network architecture shown in FIG. 1. The method includes the following processes.

In process 401, first configuration information from a network-side device is received.

The network-side device may be an access network device in a mobile communication network. For example, the network-side device may be the network-side device 110, the satellite 140, the satellite 160, or the base station 170 in the network architecture shown in FIG. 1.

In the embodiments of the present disclosure, the network-side device may transmit the first configuration information to the terminal device. The first configuration information may be transmitted over a system message, or the first configuration information may be transmitted over a terminal device-specific channel/signal. The transmission manner of the first configuration information is not limited in the embodiments of the present disclosure.

In process 402, a first duration is acquired based on the first configuration information, wherein the first duration is not configured for transmission of a first channel or signal of a first cell.

In the embodiments of the present disclosure, the first duration being not configured for transmission of the first channel or signal may mean that the network-side device does not transmit the first channel or signal within the first duration.

In some embodiments, the network-side device indicates, over the first configuration information, to each terminal device corresponding to the network-side device the first duration where the first channel or signal is not transmitted, that is, the network-side device does not transmit (including receiving and/or transmitting) the first channel or signal within the first duration, such that the energy consumption of the network-side device is reduced.

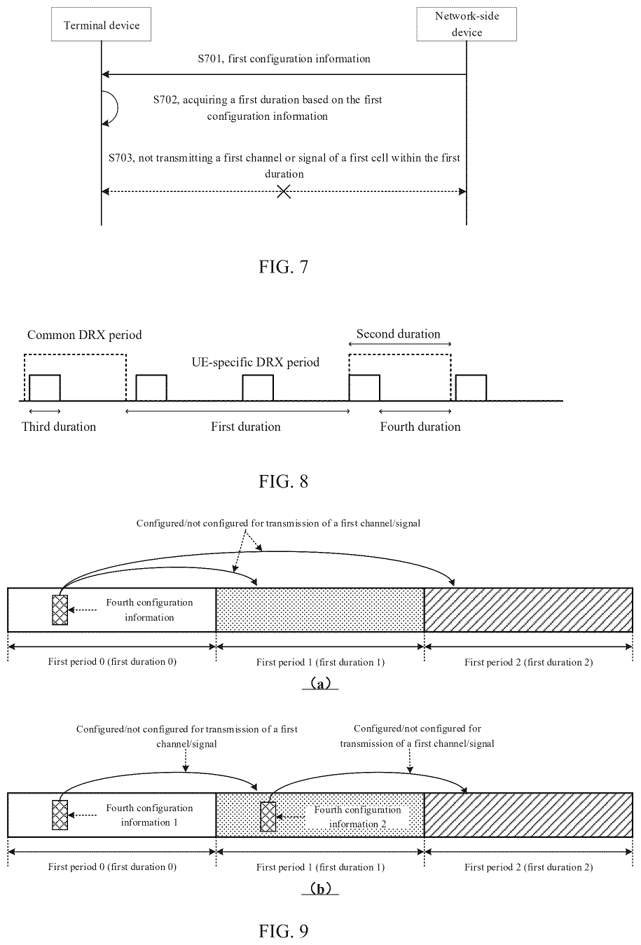

In some embodiments, for the above solutions applicable to the terminal device, reference is specifically made to the description in the subsequent embodiments shown in FIG. 7.

In summary, in the solutions according to the embodiments of the present disclosure, the terminal device is capable of determining the first duration based on the first configuration information from the network-side device, and the first channel or signal is not transmitted between the terminal device and the network-side device within the first duration. In this way, the network-side device does not transmit or receive the first channel or signal within the first duration, such that the energy consumption of the network-side device is reduced, and network energy saving is achieved.

In addition, in the embodiments of the present disclosure, as the terminal device does not transmit the first channel or signal within the first duration neither, by the above solutions, the energy consumption of the terminal device is periodically reduced as well.

In an NR system and an evolved system thereof, with the solutions according to the embodiments of the present disclosure, the network-side device may configure a DRX period for the terminal device in a common manner, and the network-side device and the terminal device agree not to receive a first downlink channel or signal within the first duration of the common DRX period. Accordingly, the network-side device does not transmit the first downlink channel or signal within the first duration, such that network energy saving is achieved.

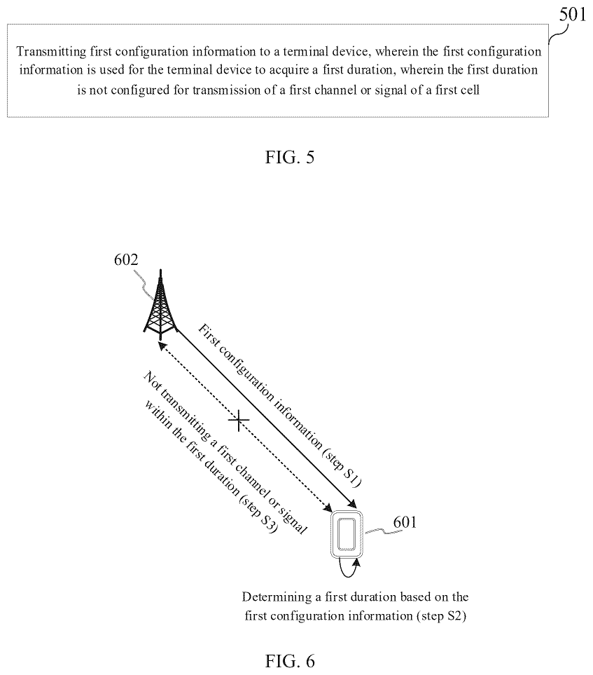

Referring to FIG. 5, a flowchart of a method for wireless communication according to some embodiments of the present disclosure is shown. The method is applicable to a network-side device, and the network-side device may be the network-side device 110, the satellite 140, the satellite 160, or the base station 170 in the network architecture shown in FIG. 1. The method includes the following processes.

In process 501, first configuration information is transmitted to a terminal device, wherein the first configuration information is used for the terminal device to acquire a first duration, wherein the first duration is not configured for transmission of a first channel or signal of a first cell.

In some embodiments, for the above solutions applicable to the network-side device, reference is specifically made to the description in the subsequent embodiments shown in FIG. 7.

In summary, in the solutions according to the embodiments of the present disclosure, the network-side device may transmit the first configuration information to the terminal device, such that the terminal device determines the first duration based on the first configuration information from the network-side device, and the first channel or signal is not transmitted between the terminal device and the network-side device within the first duration. In this way, the network-side device does not transmit or receive the first channel or signal within the first duration, such that the energy consumption of the network-side device is reduced, and network energy saving is achieved.

In addition, in the embodiments of the present disclosure, as the terminal device does not transmit the first channel or signal within the first duration neither, by the above solutions, the energy consumption of the terminal device is periodically reduced as well.

Referring to FIG. 6, a schematic diagram of a wireless communication flow according to some embodiments of the present disclosure is shown. As shown in FIG. 6, the terminal device 601 and the network-side device 602 communicate with each other over radio signals.

Using the network-side device 602 being a base station as an example, in FIG. 6, the network-side device 602 first transmits first configuration information to the terminal device 601 (step S1), which may indicate a first duration corresponding to a first cell. The terminal device 601 determines the first duration corresponding to the first cell based on the first configuration information. Subsequently, a first channel or signal is not transmitted between the terminal device 601 and the network-side device 602 within the first duration.

Based on the solutions according to the above embodiments shown in FIG. 4 and FIG. 5, referring to FIG. 7, a flowchart of a method for wireless communication according to some embodiments of the present disclosure is shown. The method is interactively performed between a terminal device and a network-side device. The terminal device and the network-side device may be the terminal device 120 and the network-side device 110 in the network architecture shown in FIG. 1. Alternatively, the terminal device and the network-side device may be the terminal device 130 and the satellite 140/satellite 160 in the network architecture shown in FIG. 1. Alternatively, the terminal device and the network-side device may be the terminal device 150 and the base station 170 in the network architecture shown in FIG. 1. As shown in FIG. 7, the method includes at least a portion of the following processes.

In process 701, the network-side device transmits first configuration information to the terminal device; and accordingly, the terminal device receives the first configuration information from the network-side device.

In some embodiments, the first configuration information is carried in at least one of: a system message, a cell-common radio resource control (RRC) message, a group-common RRC message, a terminal device-specific RRC message, a cell-common medium access control (MAC) control element (CE) message, a group-common MAC CE message, a terminal device-specific MAC CE message, a cell-common downlink control information (DCI) message, a group-common DCI message, or a terminal device-specific DCI message.

For example, the network-side device may transmit the first configuration information to the terminal device over a system message or RRC signaling.

Alternatively, the network-side device may transmit the first configuration information to the terminal device in a random access procedure. For example, the network-side device transmits the first configuration information to the terminal device over a random access response message in the random access procedure (for example, a message 2 in a four-step random access procedure or a message B in a two-step random access procedure) or over a contention resolution message in the random access procedure (for example, a message 4).

In process 702, the terminal device acquires a first duration based on the first configuration information, wherein the first duration is not configured for transmission of a first channel or signal of a first cell.

In some embodiments, process 702 is replaced with the following process: the terminal device acquires a first duration based on the first configuration information, wherein the first duration is configured for transmission of a first channel or signal of a first cell.

In some embodiments, the process that the terminal device acquires the first duration based on the first configuration information includes: based on the first configuration information, acquiring, by the terminal device, at least one of: a length of the first duration, a start subframe of the first duration, a start slot of the first duration, a start symbol of the first duration, an end position of the first duration, and fourth configuration information associated within the first duration.

In some embodiments, the first cell includes one of: one cell, a plurality of cells, one cell group, a plurality of cell groups, all activated cells of the terminal device, a portion of activated cells of the terminal device, all configured cells of the terminal device, and a portion of configured cells of the terminal device.

In some embodiments, the first cell is a cell associated with an energy saving mode, or the first cell is a cell configured in the energy saving mode.

In some embodiments, the first cell does not include a primary cell of the terminal device, and/or the first cell does not include a primary cell in a secondary cell group of the terminal device.

In some embodiments, the length of the first duration is fixed.

In some embodiments, the length of the first duration is variable depending on scheduling.

In some embodiments, the first duration is configured periodically.

In some embodiments, the first duration is configured aperiodically.

In some embodiments, the process that the terminal device acquires the first duration based on the first configuration information includes: determining, by the terminal device, a start position of the first duration based on a first time domain resource, wherein the first time domain resource is used for transmission of response information corresponding to the first configuration information. In some embodiments, in the case that the first time domain resource includes a plurality of time domain resources, the terminal device determines the start position of the first duration based on the earliest time domain resource in the first time domain resource, or the terminal device determines the start position of the first duration based on the latest time domain resource in the first time domain resource.

In some embodiments, in the case that the first configuration information is common configuration information, for example, cell-common or group-common configuration information, the first time domain resource corresponding to the first configuration information includes one or more time domain resources, and/or the first time domain resource corresponds to one or more feedback resources. In some embodiments, the feedback resource is a physical uplink control channel (PUCCH) resource or a physical uplink shared channel (PUSCH) resource. In some embodiments, in the case that the first time domain resource corresponding to the first configuration information corresponds to a feedback resource, the response information corresponding to the first configuration information, of which the feedback resource is configured for transmission, includes only negative acknowledge (NACK) information. In some embodiments, in the case that the first time domain resource corresponding to the first configuration information corresponds to a plurality of feedback resources, each of the plurality of feedback resources is configured for a terminal device to transmit the response information corresponding to the first configuration information. For example, the number of terminal devices receiving the first configuration information is the same as the number of feedback resources corresponding to the first time domain resource, and each of the plurality of feedback resources is in one-to-one correspondence to each of the terminal devices. In some embodiments, in the case that the first time domain resource corresponding to the first configuration information corresponds to a plurality of feedback resources, each of the plurality of feedback resources is configured for a group of terminal devices to transmit the response information corresponding to the first configuration information. For example, the number of groups of terminal devices receiving the first configuration information is the same as the number of feedback resources corresponding to the first time domain resource, and each of the plurality of feedback resources is in one-to-one correspondence to each of the groups of terminal devices.

For example, the terminal device receives the first configuration information over a first downlink resource, and transmits ACK information corresponding to the first configuration information over a first uplink resource (i.e., the first time domain resource), such that the terminal device determines the start position of the first duration based on the first uplink resource. For example, the start position of the first duration is subsequent to a position of the first uplink resource, and a time distance between the start position (for example, the start slot) of the first duration and the position (for example, a slot) of the first uplink resource is a first offset value. The first offset value is preset or configured by the network-side device or determined based on a capability of the terminal device.

By way of example but not limitation, the first configuration information is transmitted over a physical downlink shared channel (PDSCH) including a medium access control (MAC) control element (CE) command/message. The ACK information corresponding to the MAC CE command/message is transmitted over a slot n, the start slot of the first duration is a K^{th} slot after a slot (n+3N), N represents the number of slots included in each subframe under a subcarrier spacing configuration μ, and K is a positive integer. For example, the value of K may be 1.

In some embodiments, the MAC CE is a terminal device-specific MAC CE.

In some embodiments, the MAC CE is a group-common or cell-common MAC CE. In further embodiments, the slot n is a slot earliest in an ACK information transmission slot corresponding to the MAC CE command, or the slot n is a slot latest in an ACK information transmission slot corresponding to the MAC CE command. Alternatively, the slot n is a slot for the terminal device to transmit the ACK information, and the slots n corresponding to different terminal devices are the same or different.

In some embodiments, the first channel or signal includes a first downlink channel or signal, and the first duration being not configured for transmission of the first channel or signal of the first cell includes:

a first downlink resource within the first duration being not used for transmission of the first downlink channel or signal of the first cell, wherein the first downlink resource is a resource configured for transmission of the first downlink channel or signal.

In the embodiments of the present disclosure, the first duration being not configured for transmission of the first channel or signal of the first cell, may mean that the first downlink resource within the first duration is not configured for transmission of the first downlink channel or signal of the first cell.

In the embodiments of the present disclosure, the first downlink resource allowing transmission of the first downlink channel or signal means that the first downlink resource may be used for transmission of the first downlink channel or signal. For example, the first downlink resource may be a configured or protocol-specified resource for transmission of the first downlink channel or signal.

For example, the first downlink channel or signal is a synchronization signal and physical broadcast channel (PBCH) block (SSB). It is assumed that a configured SSB transmission period is 10 ms and a time domain position of SSB transmission is the first two slots in every 10 ms. System frame numbers (SFNs) corresponding to the first duration are SFN m to SFN n, and then the first downlink resource is a resource for SSB transmission on the first two slots in each of SFNs of the first duration, i.e., SFN m to SFN n. Accordingly, the network-side device does not transmit an SSB on the resource for SSB transmission on the first two slots in each of the SFNs from SFN m to SFN n, and the terminal device does not receive an SSB on the resource for SSB transmission on the first two slots in each of the SFNs from SFN m to SFN n.

In some embodiments, in the case that the first downlink resource within the first duration is not configured for transmission of the first downlink channel or signal of the first cell, an action of the terminal device includes at least one of the following cases:

1) No receive operation is performed on the first downlink resource within the first duration.

In some embodiments, the terminal does not receive the downlink channel or signal on the first cell within the first duration.

In some embodiments, the terminal does not receive the downlink channel or signal on the first downlink resource of the first cell within the first duration.

2) The first downlink channel or signal is not received on the first downlink resource within the first duration.

In some embodiments, the terminal does not receive the first downlink channel or signal on the first cell within the first duration.

In some embodiments, the terminal does not receive the first downlink channel or signal on the first downlink resource of the first cell within the first duration.

3) It is assumed that the network-side device does not transmit a downlink channel or signal on the first downlink resource within the first duration, or the network-side device is not expected to transmit a downlink channel or signal on the downlink resource within the first duration.

In some embodiments, the terminal assumes that the network-side device does not transmit the downlink channel or signal on the first cell within the first duration, or does not expect the network-side device to transmit the downlink channel or signal on the first cell within the first duration.

In some embodiments, the terminal assumes that the network-side device does not transmit the downlink channel or signal on the first downlink resource of the first cell within the first duration, or does not expect the network-side device to transmit the downlink channel or signal on the first downlink resource of the first cell within the first duration.

4) It is assumed that the network-side device does not transmit the first downlink channel or signal on the first downlink resource within the first duration, or the network-side device is not expected to transmit the first downlink channel or signal on the first downlink resource within the first duration.

In some embodiments, the terminal assumes that the network-side device does not transmit the first downlink channel or signal on the first cell within the first duration, or does not expect the network-side device to transmit the first downlink channel or signal on the first cell within the first duration.

In some embodiments, the terminal assumes that the network-side device does not transmit the first downlink channel or signal on the first downlink resource of the first cell within the first duration, or does not expect the network-side device to transmit the first downlink channel or signal on the first downlink resource of the first cell within the first duration.

In some embodiments, in the case that the first downlink resource within the first duration is not configured for transmission of the first downlink channel or signal of the first cell, an action of the network-side device includes at least one of the following cases:

1) It is assumed that the terminal device performs no receive operation on the first downlink resource within the first duration.

In some embodiments, the network-side device assumes that the terminal device does not receive the downlink channel or signal on the first cell within the first duration, or does not expect the terminal device to receive the downlink channel or signal on the first cell within the first duration.

In some embodiments, the network-side device assumes that the terminal device does not receive the downlink channel or signal on the first downlink resource of the first cell within the first duration, or does not expect the terminal device to receive the downlink channel or signal on the first downlink resource of the first cell within the first duration.

2) It is assumed that the terminal device does not receive the first downlink channel or signal on the first downlink resource within the first duration.

In some embodiments, the network-side device assumes that the terminal device does not receive the first downlink channel or signal on the first cell within the first duration, or does not expect the terminal device to receive the first downlink channel or signal on the first cell within the first duration.

In some embodiments, the network-side device assumes that the terminal device does not receive the first downlink channel or signal on the first downlink resource of the first cell within the first duration, or does not expect the terminal device to receive the first downlink channel or signal on the first downlink resource of the first cell within the first duration.

3) A downlink channel or signal is not transmitted on the first downlink resource within the first duration.

In some embodiments, the network-side device does not transmit the downlink channel or signal on the first cell within the first duration.

In some embodiments, the network-side device does not transmit the downlink channel or signal on the first downlink resource of the first cell within the first duration.

4) The first downlink channel or signal is not transmitted on the first downlink resource within the first duration.

In some embodiments, the network-side device does not transmit the first downlink channel or signal on the first cell within the first duration.

In some embodiments, the network-side device does not transmit the first downlink channel or signal on the first downlink resource of the first cell within the first duration.

In some embodiments, a downlink channel or signal included in the first downlink channel or signal is predefined.

Alternatively, a downlink channel or signal included in the first downlink channel or signal is determined based on second configuration information of the network-side device.

For example, the downlink channel or signal included in the first downlink channel or signal is predefined by a protocol, or the downlink channel or signal included in the first downlink channel or signal is determined based on configuration information that is transmitted by the network-side device in advance over a system message, RRC signaling, a random access message, or the like.

In some embodiments, the second configuration information is carried in at least one of: a system message, a cell-common RRC message, a group-common RRC message, a terminal device-specific RRC message, a cell-common MAC CE message, a group-common MAC CE message, a terminal device-specific MAC CE message, a cell-common DCI message, a group-common DCI message, or a terminal device-specific DCI message.

In some embodiments, the first channel or signal includes a first uplink channel or signal, and the first duration being not configured for transmission of the first channel or signal of the first cell includes:
a first uplink resource within the first duration being not used for transmission of the first uplink channel or signal of the first cell, wherein the first uplink resource is a resource configured for transmission of the first uplink channel or signal.

In the embodiments of the present disclosure, the first duration being not configured for transmission of the first channel or signal of the first cell may mean that the first uplink resource within the first duration is not configured for transmission of the first uplink channel or signal of the first cell.

In the embodiments of the present disclosure, the first uplink resource being a resource configured for transmission of the first uplink channel or signal means that the first uplink resource may be used for transmission of the first uplink channel or signal. For example, the first uplink resource may be a configured or protocol-specified resource for transmission of the first uplink channel or signal.

For example, the first uplink channel or signal is a physical random access channel (PRACH). It is assumed that a configured PRACH transmission period is 10 ms and a time domain position of PRACH transmission is a fifth slot in every 10 ms. System frame numbers corresponding to the first duration are SFN m to SFN n, and then the first uplink resource is a resource for PRACH transmission on the fifth slot in each of SFNs of the first duration, i.e., SFN m to SFN n. Accordingly, the terminal device is not allowed to transmit the PRACH on the resource for PRACH transmission on the fifth slot in each of the SFNs from SFN m to SFN n, and the network-side device does not receive the PRACH on the resource for PRACH transmission on the fifth slot in each of the SFNs from SFN m to SFN n.

In some embodiments, in the case that the first uplink resource within the first duration is not configured for transmission of the first uplink channel or signal of the first cell, the action of the terminal device includes at least one of the following cases:
1) No transmit operation is performed on the first uplink resource within the first duration.

In some embodiments, the terminal device does not perform the transmit operation on the first cell within the first duration.

In some embodiments, the terminal device does not perform the transmit operation on the first uplink resource of the first cell within the first duration.
2) The first uplink channel or signal is not transmitted on the first uplink resource within the first duration.

In some embodiments, the terminal device does not transmit the first uplink channel or signal on the first cell within the first duration.

In some embodiments, the terminal device does not transmit the first uplink channel or signal on the first uplink resource of the first cell within the first duration.
3) It is assumed that the network-side device does not receive an uplink channel or signal on the first uplink resource within the first duration, or the network-side device is not expected to receive an uplink channel or signal on the uplink resource within the first duration.

In some embodiments, the terminal device assumes that the network-side device does not receive the uplink channel or signal on the first cell within the first duration, or does not expect the network-side device to receive the uplink channel or signal on the first cell within the first duration.

In some embodiments, the terminal device assumes that the network-side device does not receive the uplink channel or signal on the first uplink resource of the first cell within the first duration, or does not expect the network-side device to receive the uplink channel or signal on the first uplink resource of the first cell within the first duration.
4) It is assumed that the network-side device does not receive the first uplink channel or signal on the first uplink resource within the first duration, or the network-side device is not expected to receive the first uplink channel or signal on the first uplink resource within the first duration.

In some embodiments, the terminal device assumes that the network-side device does not receive the first uplink channel or signal on the first cell within the first duration, or does not expect the network-side device to receive the first uplink channel or signal on the first cell within the first duration.

In some embodiments, the terminal device assumes that the network-side device does not receive the first uplink channel or signal on the first uplink resource of the first cell within the first duration, or does not expect the network-side device to receive the first uplink channel or signal on the first uplink resource of the first cell within the first duration.

In some embodiments, in the case that the first uplink resource within the first duration is not configured for transmission of the first uplink channel or signal of the first cell, the action of the network-side device includes at least one of the following cases:
1) It is assumed that the terminal device performs no transmit operation on the first uplink resource within the first duration.

In some embodiments, the network-side device assumes that the terminal device performs no transmit operation on the first cell within the first duration.

In some embodiments, the network-side device assumes that the terminal device performs no transmit operation on the first uplink resource of the first cell within the first duration.
2) It is assumed that the terminal device does not transmit the first uplink channel or signal on the first uplink resource within the first duration.

In some embodiments, the network-side device assumes that the terminal device does not transmit the first uplink channel or signal on the first cell within the first duration.

In some embodiments, the network-side device assumes that the terminal device does not transmit the first uplink channel or signal on the first uplink resource of the first cell within the first duration.
3) An uplink channel or signal is not received on the first uplink resource within the first duration.

In some embodiments, the network-side device does not receive the uplink channel or signal on the first cell within the first duration.

In some embodiments, the network-side device does not receive the uplink channel or signal on the first uplink resource of the first cell within the first duration.
4) The first uplink channel or signal is not received on the first uplink resource within the first duration.

In some embodiments, the network-side device does not receive the first uplink channel or signal on the first cell within the first duration.

In some embodiments, the network-side device does not receive the first uplink channel or signal on the first uplink resource of the first cell within the first duration.

In some embodiments, the first channel or signal includes the first downlink channel or signal and the first uplink channel or signal, and the first duration being not configured for transmission of the first channel or signal of the first cell includes:
the first downlink resource within the first duration being not configured for transmission of the first downlink channel or signal of the first cell, and the first uplink resource within the first duration being not configured for transmission of the first uplink channel or signal of the first cell, wherein the first downlink resource is a resource configured for transmission of the first downlink channel or signal, and the first uplink resource is a resource configured for transmission of the first uplink channel or signal.

It should be noted that in some embodiments, in the case that the terminal device assumes that the network-side device does not transmit the first downlink channel or signal within the first duration, it is considered that the network-side device does not transmit the first downlink channel or signal within the first duration. In the case that the first downlink channel or signal includes a specific downlink channel or signal, such as a common downlink channel or signal, it is considered that the network-side device does not transmit the common downlink channel or signal within the first duration, such that energy saving is achieved to some extent. In the case that the first downlink channel or signal includes all downlink channels or signals, it is considered that the network-side device does not transmit any one of the downlink channels or signals within the first duration. For example, the network-side device is in a sleep state within the first duration, such that energy saving is achieved.

In some embodiments, in the case that the terminal device assumes that the network-side device does not receive the first uplink channel or signal within the first duration, it is considered that the network-side device does not receive the first uplink channel or signal within the first duration. In the case that the first uplink channel or signal includes a specific uplink channel or signal, such as a PRACH, it is considered that the network-side device does not detect the PRACH within the first duration, such that energy saving is achieved to some extent. In the case that the first uplink channel or signal includes all uplink channels or signals, it is considered that the network-side device does not receive any one of the uplink channels or signals within the first duration. For example, the network-side device is in a sleep state within the first duration, such that energy saving is achieved.

In some embodiments, in the case that the terminal device and the network-side device agree not to transmit the downlink channel or signal and the uplink channel or signal within the first duration, both the terminal device and the network-side device are in a sleep state within the first duration, such that energy saving is achieved.

In some embodiments, the terminal device does not receive the downlink channel or signal, i.e., the terminal device does not detect the downlink channel or signal. For example, in the case that the downlink channel or signal includes a PDCCH, the terminal device does not receive the PDCCH, which may mean that the terminal device does not monitor the PDCCH.

In some embodiments, the network-side device does not receive the uplink channel or signal, i.e., the network-side device does not detect the uplink channel or signal. For example, in the case that the uplink channel or signal includes a PRACH, the network-side device does not receive the PRACH, which may mean that the network-side device does not detect the PRACH.

In some embodiments, energy saving of the network-side device is associated with the transmission of the downlink channel or signal. In other embodiments, energy saving of the network-side device is associated with the reception of the uplink channel or signal. In still other embodiments, energy saving of the network-side device is associated with the transmission of the downlink channel or signal and the reception of the uplink channel or signal.

In some embodiments, an uplink channel or signal included in the first uplink channel or signal is predefined.

Alternatively, an uplink channel or signal included in the first uplink channel or signal is determined based on third configuration information of the network-side device.

In some embodiments, the third configuration information is carried in at least one of: a system message, a cell-common RRC message, a group-common RRC message, a terminal device-specific RRC message, a cell-common MAC CE message, a group-common MAC CE message, a terminal device-specific MAC CE message, a cell-common DCI message, a group-common DCI message, or a terminal device-specific DCI message.

In some embodiments, whether the first duration is configured for transmission of the first channel or signal of the first cell is determined based on fourth configuration information of the network-side device.

In some embodiments, the fourth configuration information includes at least one of:
a first wake-up signal associated within the first duration, for example, a reference signal associated within the first duration includes a wake-up signal (WUS) associated within the first duration;
a first PDCCH associated within the first duration;
a first system message associated within the first duration;
a first MAC CE message associated within the first duration; and a first RRC message associated within the first duration.

In some embodiments of the present disclosure, a plurality of first durations are present. For example, a first duration 1 and a first duration 2 are present. Assuming that the fourth configuration information is a PDCCH, the first duration 1 is associated with a PDCCH 1, and that the first duration 2 is associated with a PDCCH 2, then whether the first duration 1 is configured for transmission of the first channel or signal of the first cell is determined based on the PDCCH 1; and whether the first duration 2 is configured for transmission of the first channel or signal of the first cell is determined based on the PDCCH 2. That is, whether each first duration is configured for transmission of the first channel or signal of the first cell is independently determined based on the corresponding fourth configuration information.

In some embodiments, the fourth configuration information is carried in at least one of: a system message, a cell-common RRC message, a group-common RRC message, a terminal device-specific RRC message, a cell-common MAC CE message, a group-common MAC CE message, a terminal device-specific MAC CE message, a cell-common DCI message, a group-common DCI message, and a terminal device-specific DCI message.

By way of example but not limitation, the fourth configuration information includes 1 bit, and in the case that the bit indicates 1, the first duration is not configured for transmission of the first channel or signal of the first cell; and/or in the case that the bit indicates 0, the first duration is configured for transmission of the first channel or signal of the first cell.

By way of another example and not limitation, in the case that the network-side device is configured with the fourth configuration information, the first duration is not configured for transmission of the first channel or signal of the first cell; and/or in the case that the network-side device is not configured with the fourth configuration information, the first duration is configured for transmission of the first channel or signal of the first cell.

In some embodiments, whether the first duration in the first period is configured for transmission of the first channel or signal of the first cell is protocol-agreed.

In some embodiments, the first channel or signal includes the first downlink channel or signal. In the case that the first duration is configured for transmission of the first channel or signal of the first cell, the method includes: transmitting, by the network-side device, the first downlink channel or signal of the first cell on the first downlink resource within the first duration, and/or receiving, by the terminal device, the first downlink channel or signal of the first cell on the first downlink resource within the first duration.

In some embodiments, the network-side device transmits the first downlink channel or signal of the first cell only on the first downlink resource within the first duration, and/or the terminal device receives the first downlink channel or signal of the first cell only on the first downlink resource within the first duration. That is, the network-side device does not transmit the first downlink channel or signal of the first cell on the first downlink resource except within the first duration, and/or the terminal device does not receive the first downlink channel or signal of the first cell on the first downlink resource except within the first duration.

In some embodiments, the first channel or signal includes the first uplink channel or signal. In the case that the first duration is configured for transmission of the first channel or signal of the first cell, the method includes: transmitting, by the terminal device, the first uplink channel or signal of the first cell on the first uplink resource within the first duration, and/or receiving, by the network-side device, the first uplink channel or signal of the first cell on the first uplink resource within the first duration.

In some embodiments, the terminal device transmits the first uplink channel or signal of the first cell only on the first uplink resource within the first duration, and/or the network-side device receives the first uplink channel or signal of the first cell only on the first uplink resource within the first duration. That is, the terminal device does not transmit the first uplink channel or signal of the first cell on the first uplink resource except within the first duration, and/or the network-side device does not receive the first uplink channel or signal of the first cell on the first uplink resource except within the first duration.

In some embodiments, the first channel or signal includes the first downlink channel or signal and the first uplink channel or signal. In the case that the first duration is configured for transmission of the first channel or signal of the first cell, the method includes: transmitting, by the network-side device, the first downlink channel or signal of the first cell on the first downlink resource within the first duration and receiving the first uplink channel or signal of the first cell on the first uplink resource within the first duration; and/or receiving, by the terminal device, the first downlink channel or signal of the first cell on the first downlink resource within the first duration and transmitting the first uplink channel or signal of the first cell on the first uplink resource within the first duration.

In some embodiments, the network-side device transmits the first downlink channel or signal of the first cell only on the first downlink resource within the first duration and receives the first uplink channel or signal of the first cell only on the first uplink resource within the first duration; and/or the terminal device receives the first downlink channel or signal of the first cell only on the first downlink resource within the first duration and transmits the first uplink channel or signal of the first cell only on the first uplink resource within the first duration. That is, the network-side device does not transmit the first downlink channel or signal of the first cell on the first downlink resource except within the first duration and does not receive the first uplink channel or signal of the first cell on the first uplink resource except within the first duration; and/or the terminal device does not receive the first downlink channel or signal of the first cell on the first downlink resource except within the first duration and does not transmit the first uplink channel or signal of the first cell on the first uplink resource except within the first duration.

In the embodiments of the present disclosure, the first duration may be an aperiodic duration. Alternatively, the first duration may be a periodic duration.

In some embodiments, acquiring the first duration based on the first configuration information includes:
acquiring a first period based on the first configuration information, wherein the first period corresponds to the first cell and the first period includes the first duration.

In some embodiments, the first configuration information directly carries period information of the first period. For example, the period information further includes a start time point/an offset of a start time point of the first duration, a length of the first duration, an end time point/an offset of an end time point of the first duration, and the like.

In some embodiments, the first configuration information carries indication information for indirectly determining period information of the first period. For example, the first configuration information carries an identifier corresponding to the period information of the first period, or the first configuration information carries relevant information for calculating a start time point/an offset of a start time point, a length of the first duration, or an end time point/an offset of an end time point of the first duration.

In the embodiments of the present disclosure, as the first period is a period corresponding to the first cell, the first duration being not configured for transmission of the first channel or signal of the first cell, may mean that the first duration in the first period is not configured for transmission of the first channel or signal. Accordingly, the first duration being configured for transmission of the first channel or signal of the first cell, may mean that the first duration in the first period is configured for transmission of the first channel or signal.

In some embodiments, the fourth configuration information of the network-side device further includes at least one of:
a first wake-up signal associated with the first period, for example, a reference signal associated with the first period includes a wake-up signal associated with the first period;
a first PDCCH associated with the first period;
a first system message associated with the first period;
a first MAC CE message associated with the first period; and
a first RRC message associated with the first period.

In some embodiments of the present disclosure, a plurality of first periods are present, such as a first period 1 and a first period 2, wherein the first period 1 includes a first duration 1, and the first period 2 includes a first duration 2. Assuming that the fourth configuration information is a PDCCH, the first period 1 is associated with a PDCCH 1, and that the first period 2 is associated with a PDCCH 2, then whether the first duration 1 in the first period 1 is configured for transmission of the first channel or signal of the first cell is determined based on the PDCCH 1; and whether the first duration 2 in the first period 2 is configured for transmission of the first channel or signal of the first cell is determined based on the PDCCH 2. That is, whether the first duration in each first period is configured for transmission of the first channel or signal of the first cell is independently determined based on the corresponding fourth configuration information.

In some embodiments, the first period including the first duration, is one of the following cases:
the first duration is the first period;
a start position of the first period is the same as a start position of the first duration;
an end position of the first period is the same as an end position of the first duration; or
a start position of the first period is the same as a start position of the first duration, and an end position of the first period is the same as an end position of the first duration.

In some embodiments, the first period further includes a second duration, and the second duration is configured for transmission of the first channel or signal of the first cell.

In some embodiments, the length of the second duration is fixed.

In some embodiments, the length of the second duration is variable depending on scheduling.

In some embodiments, the first channel or signal includes the first downlink channel or signal and/or the first uplink channel or signal.

The second duration being configured for transmission of the first channel or signal of the first cell includes at least one of:
a second downlink resource within the second duration being used for transmission of the first downlink channel or signal of the first cell; or
a second uplink resource within the second duration being used for transmission of the first uplink channel or signal of the first cell.

The second downlink resource is a resource configured for transmission of the first downlink channel or signal.

The second uplink resource is a resource configured for transmission of the first uplink channel or signal.

In some embodiments, the first channel or signal includes the first downlink channel or signal and/or the first uplink channel or signal, and the action of the terminal device includes at least one of the following cases:
1) The first downlink channel or signal is monitored or received on the second downlink resource within the second duration.

In some embodiments, the terminal device monitors or receives the first downlink channel or signal on the first cell within the second duration.

In some embodiments, the terminal device monitors or receives the first downlink channel or signal on the second downlink resource of the first cell within the second duration.
2) The first uplink channel or signal is transmitted on the second uplink resource within the second duration.

In some embodiments, the terminal device transmits the first uplink channel or signal on the first cell within the second duration.

In some embodiments, the terminal device transmits the first uplink channel or signal on the second uplink resource of the first cell within the second duration.
3) The first uplink channel or signal is transmitted on the second uplink resource within the second duration in the case that a transport block to be transmitted is present in the terminal device.

In some embodiments, the terminal device transmits the first uplink channel or signal on the first cell within the second duration in the case that the transport block to be transmitted is present in the terminal device.

In some embodiments, the terminal device transmits the first uplink channel or signal on the second uplink resource of the first cell within the second duration in the case that the transport block to be transmitted is present in the terminal device.
4) It is assumed that the network-side device is allowed to transmit the first downlink channel or signal on the second downlink resource within the second duration.

In some embodiments, the terminal device assumes that the network-side device is allowed to transmit the first downlink channel or signal on the first cell within the second duration.

In some embodiments, the terminal device assumes that the network-side device is allowed to transmit the first downlink channel or signal on the second downlink resource of the first cell within the second duration.
5) It is assumed that the network-side device is allowed to receive the first uplink channel or signal on the second uplink resource within the second duration.

In some embodiments, the terminal device assumes that the network-side device is allowed to receive the first uplink channel or signal on the first cell within the second duration.

In some embodiments, the terminal device assumes that the network-side device is allowed to receive the first uplink channel or signal on the second uplink resource of the first cell within the second duration.

In some embodiments, in the case that the second duration is configured for transmission of the first channel or signal of the first cell, the action of the network-side device includes at least one of the following cases:
1) It is assumed that the terminal device monitors or receives the first downlink channel or signal on the second downlink resource within the second duration.

In some embodiments, the network-side device assumes that the terminal device monitors or receives the first downlink channel or signal on the first cell within the second duration.

In some embodiments, the network-side device assumes that the terminal device monitors or receives the first downlink channel or signal on the second downlink resource of the first cell within the second duration.
2) It is assumed that the terminal device transmits the first uplink channel or signal on the second uplink resource within the second duration.

In some embodiments, the network-side device assumes that the terminal device transmits the first uplink channel or signal on the first cell within the second duration.

In some embodiments, the network-side device assumes that the terminal device transmits the first uplink channel or signal on the second uplink resource of the first cell within the second duration.
3) It is assumed that the terminal device transmits the first uplink channel or signal on the second uplink resource within the second duration in the case that a transport block to be transmitted is present in the terminal device.

In some embodiments, the network-side device assumes that the terminal device transmits the first uplink channel or signal on the first cell within the second duration in the case that the transport block to be transmitted is present in the terminal device.

In some embodiments, the network-side device assumes that the terminal device transmits the first uplink channel or signal on the second uplink resource of the first cell within the second duration in the case that the transport block to be transmitted is present in the terminal device.
4) The first downlink channel or signal is allowed to be transmitted on the second downlink resource within the second duration.

In some embodiments, the network-side device is allowed to transmit the first downlink channel or signal on the first cell within the second duration.

In some embodiments, the network-side device is allowed to transmit the first downlink channel or signal on the second downlink resource of the first cell within the second duration.
5) The first uplink channel or signal is allowed to be received on the second uplink resource within the second duration.

In some embodiments, the network-side device is allowed to receive the first uplink channel or signal on the first cell within the second duration.

In some embodiments, the network-side device is allowed to receive the first uplink channel or signal on the second uplink resource of the first cell within the second duration.

In some embodiments, in some exemplary solutions according to the embodiments of the present disclosure, in the case that the terminal device assumes that the network-side device transmits the first downlink channel or signal within the second duration, the terminal device monitors or receives the first downlink channel or signal within the second duration.

In some exemplary solutions according to the embodiments of the present disclosure, in the case that the terminal device assumes that the network-side device receives the first uplink channel or signal within the second duration, the terminal device transmits the first uplink channel or signal within the second duration.

In some exemplary solutions according to the embodiments of the present disclosure, the process that the terminal device transmits the first uplink channel or signal within the second duration includes: transmitting the first uplink channel or signal within the second duration in the case that a transport block to be transmitted is present in the terminal device; and/or not transmitting the first uplink channel or signal within the second duration in the case that no transport block to be transmitted is present in the terminal device. In some embodiments, in the case that a PUSCH resource, such as a configured grant PUSCH (CG-PUSCH) resource or a scheduled PUSCH resource, is present within the second duration, the terminal device transmits the transport block to be transmitted over the PUSCH resource. In some embodiments, in the case that no PUSCH resource is present but a scheduling request (SR) resource or a PRACH resource is present within the second duration, the terminal device requests, over the SR resource or the PRACH resource, a PUSCH resource for transmission of the transport block to be transmitted from the network-side device.

In some embodiments, whether the first period includes the second duration is determined based on fifth configuration information of the network-side device.

In some embodiments, the fifth configuration information is carried in at least one of: a system message, a cell-common RRC message, a group-common RRC message, a terminal device-specific RRC message, a cell-common MAC CE message, a group-common MAC CE message, a terminal device-specific MAC CE message, a cell-common DCI message, a group-common DCI message, or a terminal device-specific DCI message.

In some embodiments of the present disclosure, the network-side device indicates whether the first period includes the second duration over the fifth configuration information, and accordingly, the terminal device determines whether the first period includes the second duration based on the fifth configuration information.

In some embodiments, the first configuration information includes configuration information for determining the first period.

In some embodiments, the first configuration information is used for determining at least one of:
a length of the first period, a start position of the first period, a length of the first duration in the first period, a start position of the first duration in the first period, an end position of the first duration in the first period, a length of the second duration in the first period, a start position of the second duration in the first period, an end position of the second duration in the first period, or the fourth configuration information associated with the first period.

In some embodiments, the first period is a common period corresponding to the first cell.

In some embodiments, the first cell includes a portion of activated cells of the terminal device or a portion of configured cells of the terminal device.

In some embodiments, the first period includes a common discontinuous reception (DRX) period, and/or the first period includes a common discontinuous transmission (DTX) period.

In some embodiments, the common DRX period includes a cell-common DRX period, or the common DRX period includes a group-common DRX period.

The common DTX period includes a cell-common DTX period, or the common DTX period includes a group-common DTX period.

For example, the first period is the group-common DRX period.

In some embodiments, in the case that the first period is a cell-common period, the first period corresponds to at least one terminal, and the at least one terminal includes at least one of:
all terminals in the cell, all terminals in an RRC connected state in the cell, all terminals in an RRC idle state in the cell, all terminals in an RRC inactive state in the cell, or all terminals in the RRC idle state and the RRC inactive state in the cell.

In some embodiments, the first period is a group-common period, and the first period corresponds to at least one terminal, and the at least one terminal includes terminals in the same group.

The terminals in the same group correspond to the same group RNTI or group identifier.

In some embodiments, the first period is a first DRX period.

The first duration includes all or a portion of times in the first DRX period excluding an active time; and/or the second duration includes the active time in the first DRX period.

In some embodiments, the active time in the first DRX period includes at least one of:
a DRX on duration, a time of the DRX in an active state, a time of DRX downlink retransmission, a time of DRX uplink retransmission, a time of DRX contention resolution, a wait time after a scheduling request is transmitted, or a time after a random access response (RAR) message is successfully received and before a PDCCH that indicates a newly transmitted cell-radio network temporary identifier (C-RNTI) scrambling code is received.

A random access preamble corresponding to the RAR is not a contention-based random access preamble.

Exemplarily, the active time in the DRX period includes: the DRX on duration (i.e., the time that a timer drx-onDurationTimer is running), the time of the DRX in an active state (i.e., the time that a timer drx-InactivityTimer is running), the time of DRX downlink retransmission (i.e., the time that a timer drx-RetransmissionTimerDL is running), the time of DRX uplink retransmission (i.e., the time that a timer drx-RetransmissionTimerUL is running), and the time of DRX contention resolution (i.e., the time that a timer ra-ContentionResolutionTimer is running).

In some embodiments, the network-side device transmits sixth configuration information to the terminal device, and accordingly, the terminal device acquires a second period based on sixth configuration information from the network-side device, wherein the second period corresponds to the first cell.

The second period includes a third duration and/or a fourth duration.

The third duration is not configured for transmission of a second channel or signal of the first cell; and the fourth duration is configured for transmission of the second channel or signal of the first cell.

The third duration is not configured for transmission of the second channel or signal of the first cell, and the fourth duration is configured for transmission of the second channel or signal of the first cell, which is similar to the case that the first duration is not configured for transmission of the first channel or signal of the first cell and the second duration is configured for transmission of the second channel or signal of the first cell, and not described herein any further.

In some embodiments, the sixth configuration information is carried in at least one of: a system message, a cell-common RRC message, a group-common RRC message, a terminal device-specific RRC message, a cell-common MAC CE message, a group-common MAC CE message, a terminal device-specific MAC CE message, a cell-common DCI message, a group-common DCI message, or a terminal device-specific DCI message.

In some embodiments, a fifth duration includes a portion of the first duration that is overlapped with the third duration in a time domain.

The fifth duration is not configured for transmission of the first channel or signal of the first cell and is not configured for transmission of the second channel or signal of the first cell.

Alternatively, the fifth duration is not configured for transmission of the first channel or signal of the first cell.

Alternatively, the fifth duration is not configured for transmission of the second channel or signal of the first cell.

Alternatively, the fifth duration is not configured for transmission of all the channels or signals of the first cell.

The fifth duration is not configured for transmission of the first channel or signal of the first cell, which is similar to the case that the first duration is not configured for transmission of the first channel or signal of the first cell, and is not described herein any further.

The fifth duration is not configured for transmission of the second channel or signal of the first cell, which is similar to the case that the first duration is not configured for transmission of the first channel or signal of the first cell, and is not described herein any further.

The fifth duration is not configured for transmission of all the channels or signals of the first cell, which is similar to the case that the first duration is not configured for transmission of the first channel or signal of the first cell, and is not described herein any further.

In some embodiments, a sixth duration includes a portion of the first duration that is overlapped with the fourth duration in a time domain.

The sixth duration is not configured for transmission of the first channel or signal of the first cell and is not configured for transmission of the second channel or signal of the first cell.

Alternatively, the sixth duration is not configured for transmission of the first channel or signal of the first cell.

Alternatively, the sixth duration is not configured for transmission of the second channel or signal of the first cell.

Alternatively, the sixth duration is not configured for transmission of all the channels or signals of the first cell.

The sixth duration is not configured for transmission of the first channel or signal of the first cell, which is similar to the case that the first duration is not configured for transmission of the first channel or signal of the first cell, and is not described herein any further.

The sixth duration is not configured for transmission of the second channel or signal of the first cell, which is similar to the case that the first duration is not configured for transmission of the first channel or signal of the first cell, and is not described herein any further.

The sixth duration is not configured for transmission of all the channels or signals of the first cell, which is similar to the case that the first duration is not configured for transmission of the first channel or signal of the first cell, and is not described herein any further.

In some embodiments, a seventh duration includes a portion of the second duration that is overlapped with the third duration in a time domain.

The seventh duration is not configured for transmission of the first channel or signal of the first cell and is not configured for transmission of the second channel or signal of the first cell.

Alternatively, the seventh duration is not configured for transmission of the first channel or signal of the first cell.

Alternatively, the seventh duration is not configured for transmission of the second channel or signal of the first cell.

Alternatively, the seventh duration is not configured for transmission of all the channels or signals of the first cell.

The seventh duration is not configured for transmission of the first channel or signal of the first cell, which is similar to the case that the first duration is not configured for transmission of the first channel or signal of the first cell, and is not described herein any further.

The seventh duration is not configured for transmission of the second channel or signal of the first cell, which is similar to the case that the first duration is not configured for transmission of the first channel or signal of the first cell, and is not described herein any further.

The seventh duration is not configured for transmission of all the channels or signals of the first cell, which is similar to the case that the first duration is not configured for transmission of the first channel or signal of the first cell, and is not described herein any further.

In some embodiments, an eighth duration includes a portion of the second duration that is overlapped with the fourth duration in a time domain.

The eighth duration is configured for transmission of the first channel or signal of the first cell and is configured for transmission of the second channel or signal of the first cell.

Alternatively, the eighth duration is configured for transmission of the first channel or signal of the first cell.

Alternatively, the eighth duration is configured for transmission of the second channel or signal of the first cell.

Alternatively, the eighth duration is configured for transmission of all the channels or signals of the first cell.

The eighth duration is configured for transmission of the first channel or signal of the first cell, which is similar to the case that the second duration is configured for transmission of the second channel or signal of the first cell, and is not described herein any further.

The eighth duration is configured for transmission of the second channel or signal of the first cell, which is similar to the case that the second duration is configured for transmission of the second channel or signal of the first cell, and is not described herein any further.

The eighth duration is configured for transmission of all the channels or signals of the first cell, which is similar to the case that the second duration is configured for transmission of the second channel or signal of the first cell, and is not described herein any further.

In some embodiments, the second period includes a terminal device-specific DRX period, and/or the second period includes a terminal device-specific DTX period.

In some embodiments, the second period is a second DRX period.

The third duration includes all or a portion of times in the second DRX period excluding an active time; and/or the fourth duration includes the active time in the second DRX period.

In some embodiments, the first downlink channel or signal includes one of:
all downlink channels or signals;
a common downlink channel or signal;
a common downlink channel or signal, and a configurably scheduled terminal device-specific downlink channel or signal;
a common downlink channel or signal, and a dynamically scheduled terminal device-specific downlink channel or signal;
a common downlink channel or signal, and a terminal device-specific downlink channel or signal;
a configurably scheduled terminal device-specific downlink channel or signal;
a dynamically scheduled terminal device-specific downlink channel or signal; or
a terminal device-specific downlink channel or signal.

In some embodiments, the common downlink channel or signal includes: a cell-common downlink channel or signal and/or a group-common downlink channel or signal. In some embodiments, the common downlink channel or signal includes: a periodically scheduled common downlink channel or signal and/or an aperiodically scheduled common downlink channel or signal. In some embodiments, the common downlink channel or signal includes at least one of: an SSB, a PDCCH or PDSCH for scheduling or transmitting a system message, a PDCCH or PDSCH for scheduling or transmitting a paging message, a PDCCH or PDSCH for scheduling or transmitting broadcast or multicast data, a PDCCH or PDSCH for scheduling or transmitting an RAR, a tracking reference signal (TRS) for tracking, a channel state information-reference signal (CSI-RS, e.g., a CSI-RS for synchronization or positioning), or a positioning reference signal (PRS) for positioning.

In some embodiments, the terminal device-specific downlink channel or signal includes: the configurably scheduled terminal device-specific downlink channel or signal, and the dynamically scheduled terminal device-specific downlink channel or signal. In some embodiments, the dynamically scheduled terminal device-specific downlink channel or signal includes at least one of a PDCCH, or a PDSCH scheduled by a PDCCH. In some embodiments, the configurably scheduled terminal device-specific downlink channel or signal includes an SPS PDSCH. In some embodiments, the configurable scheduling includes periodic scheduling and/or semi-persistent scheduling.

In some embodiments, the dynamically scheduled terminal device-specific downlink channel or signal includes: a dynamically scheduled terminal device-specific downlink channel or signal corresponding to a first priority.

In some embodiments, the configured terminal device-specific downlink channel or signal includes: a configured terminal device-specific downlink channel or signal corresponding to a first priority.

In some embodiments, the first uplink channel or signal includes one of:
all uplink channels or signals;
a PRACH;
a PRACH, and a configurably scheduled terminal device-specific uplink channel or signal;
a PRACH, and other uplink channels or signals excluding a hybrid automatic repeat request-acknowledgment (HARQ-ACK) feedback, aperiodic channel state information (CSI) reporting, and an aperiodic sounding reference signal (SRS);
a configurably scheduled terminal device-specific uplink channel or signal; or
other uplink channels or signals excluding an HARQ-ACK feedback, aperiodic CSI reporting, and an aperiodic SRS.

In some embodiments, the configurable scheduling includes periodic scheduling and/or semi-persistent scheduling. The configurable scheduling includes at least one of: a periodic SRS, a semi-persistent SRS, a periodic CSI feedback reported by a PUCCH, a semi-persistent CSI feedback reported by a PUSCH, or a CG-PUSCH.

In some embodiments, the dynamically scheduled terminal device-specific uplink channel or signal includes: a dynamically scheduled terminal device-specific uplink channel or signal corresponding to a first priority.

In some embodiments, the configured terminal device-specific uplink channel or signal includes: a configured terminal device-specific uplink channel or signal corresponding to a first priority.

In some embodiments, the second channel or signal includes a second downlink channel or signal, and the second downlink channel or signal includes one of:
a terminal device-specific downlink channel or signal, wherein the terminal device-specific downlink channel or signal includes: a configurably scheduled terminal device-specific downlink channel or signal, and a dynamically scheduled terminal device-specific downlink channel or signal;
the configurably scheduled terminal device-specific downlink channel or signal; or
the dynamically scheduled terminal device-specific downlink channel or signal.

In some embodiments, the second channel or signal includes a second uplink channel or signal, wherein the second uplink channel or signal includes one of:
a terminal device-specific uplink channel or signal, wherein the terminal device-specific uplink channel or signal includes: a configurably scheduled terminal device-specific uplink channel or signal, and a dynamically scheduled terminal device-specific uplink channel or signal;
a configurably scheduled terminal device-specific uplink channel or signal; or
a dynamically scheduled terminal device-specific uplink channel or signal.

In the embodiments of the present disclosure, at least two of the first configuration information, the second configuration information, the third configuration information, the fourth configuration information, the fifth configuration information, and the sixth configuration information are the same configuration information or different configuration information. Alternatively, at least two of the first configuration information, the second configuration information, the third configuration information, the fourth configuration information, the fifth configuration information, and the sixth configuration information are partially same or partially different configuration information.

In process 703, the terminal device and the network-side device do not transmit the first channel or signal of the first cell within the first duration.

A plurality of possible embodiments/alternatives are included in the above solutions of the embodiments of the present disclosure, and it is understood that the plurality of possible embodiments/alternatives may be used alone, or two or more of the plurality of possible embodiments/alternatives may be used in combination, which is not limited in the embodiments of the present disclosure.

Exemplarily, in the embodiments of the present disclosure, the terminal device may determine the first period and the second period based on the configuration of the network-side device, wherein the first period is a common DRX period, and the second period is a terminal device-specific DRX period.

Referring to FIG. 8, a diagram of a time domain of a first period and a second period according to some embodiments of the present disclosure is shown. As shown in FIG. 8, the first duration includes the times in the common DRX period excluding the active time, the second duration includes the active time in the common DRX period, the third duration includes the times in the terminal device-specific DRX period within the second duration excluding the active time, and the fourth duration includes the active time in the terminal device-specific DRX period within the second duration.

In a wireless communication scheme based on the diagram of the time domain shown in FIG. 8, the actions of the terminal device and the network-side device within the first duration include at least one of the following items.

The terminal device does not receive the first downlink channel or signal within the first duration, or the network-side device does not expect the terminal device to receive the first downlink channel or signal within the first duration.

The terminal device does not transmit the first uplink channel or signal within the first duration, or the network-side device does not expect the terminal device to transmit the first uplink channel or signal within the first duration.

The terminal device assumes that the network-side device does not transmit the first downlink channel or signal within the first duration, or the terminal device does not expect the network-side device to transmit the first downlink channel or signal within the first duration, wherein the first downlink channel or signal includes a common downlink channel or signal, a terminal device-specific downlink channel or signal, and a configured downlink channel or signal.

The terminal device assumes that the network-side device does not receive the first uplink channel or signal within the first duration, or the terminal device does not expect the network-side device to receive the first uplink channel or signal within the first duration, wherein the first uplink channel or signal includes a scheduled uplink channel or signal and a configured uplink channel or signal.

In a wireless communication scheme based on the diagram of the time domain shown in FIG. 8, as the second duration can be divided into the third duration and the fourth duration, the action of the terminal device within the second duration is determined based on the action of the terminal device in the third duration and the fourth duration. The action of the terminal device in the third duration includes at least one of the following items.

The terminal device does not monitor or receive the second downlink channel or signal in the third duration, wherein the second downlink channel or signal includes a terminal device-specific downlink channel or signal and a configured downlink channel or signal.

The terminal device does not transmit the second uplink channel or signal in the third duration, wherein the second uplink channel or signal includes a scheduled uplink channel or signal and a configured uplink channel or signal.

The action of the terminal device in the fourth duration includes at least one of the following items.

The terminal device monitors or receives the second downlink channel or signal in the fourth duration, wherein the second downlink channel or signal includes a terminal device-specific downlink channel or signal and a configured downlink channel or signal.

The terminal device transmits the second uplink channel or signal in the fourth duration, wherein the second uplink channel or signal includes a scheduled uplink channel or signal and a configured uplink channel or signal.

Exemplarily, in some embodiments of the present disclosure, the terminal device receives the first configuration information from the network-side device, and determines the first period based on the first configuration information, wherein the first period includes the first duration. In addition, the terminal device further receives the fourth configuration information from the network-side device, wherein the fourth configuration information indicates whether the first duration in the first period is configured (i.e., configured or not configured) for transmission of the first channel or signal of the first cell. Referring to FIG. 9, a schematic diagram illustrating an indication mode of fourth configuration information according to some embodiments of the present disclosure is shown. As an example, as shown in FIG. 9, the indication mode of the fourth configuration information includes at least one of the following two cases.

In case 1, the fourth configuration information indicates whether the first durations in a plurality of first periods are configured for transmission of the first channel or signal of the first cell.

For example, referring to part (a) in FIG. 9, the fourth configuration information transmitted by the network-side device to the terminal device in the first period 0 indicates that the first duration 1 in the first period 1 is configured or not configured for transmission of the first channel or signal of the first cell, and the fourth configuration information further indicates that the first duration 2 in the first period 2 is configured or not configured for transmission of the first channel or signal of the first cell.

In case 2, the fourth configuration information indicates whether the first duration in a first period is configured for transmission of the first channel or signal of the first cell.

For example, referring to part (b) in FIG. 9, the fourth configuration information 1 transmitted by the network-side device to the terminal device in the first period 0 indicates that the first duration 1 in the first period 1 is configured or not configured for transmission of the first channel or signal of the first cell, and the fourth configuration information 2 transmitted by the network-side device to the terminal device in the first period 1 indicates that the first duration 2 in the first period 2 is configured or not configured for transmission of the first channel or signal of the first cell.

In some embodiments, in the solutions shown in FIG. 9, the length of the first duration is the same as the length of the first period.

In some embodiments, in the solutions shown in FIG. 9, the first configuration information includes at least one of a system message, an RRC, a MAC CE, or a DCI.

In some embodiments, in the solutions shown in FIG. 9, the fourth configuration information includes at least one of a system message, an RRC, a MAC CE, or a DCI.

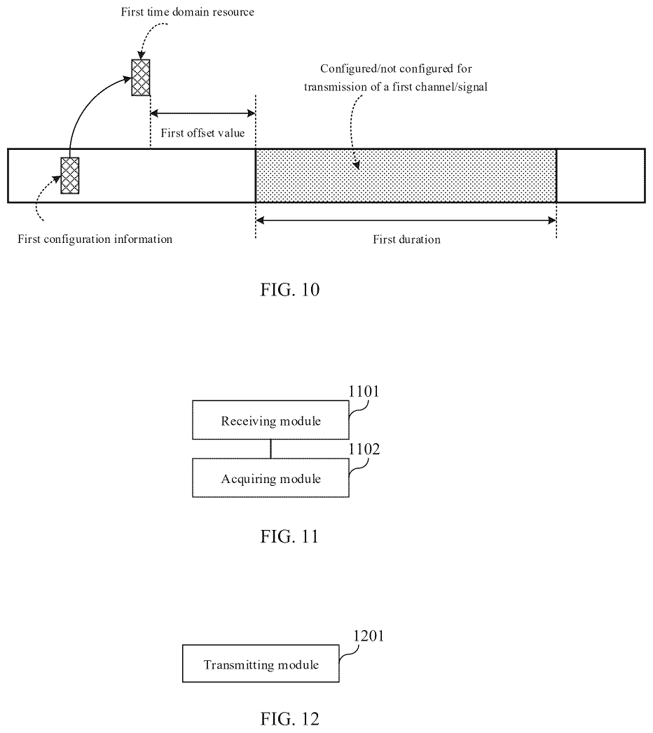

Exemplarily, in some embodiments of the present disclosure, the terminal device receives the first configuration information from the network-side device, and determines the first duration based on the first configuration information. In addition, the first configuration information is further indicates whether the first duration is configured (i.e., configured or not configured) for transmission of the first channel or signal of the first cell. Referring to FIG. 10, a schematic diagram illustrating an indication mode of first configuration information according to some embodiments of the present disclosure is shown. As an example, as shown in FIG. 10, the first configuration information indicates that the first duration is configured or not configured for transmission of the first channel or signal of the first cell. In some embodiments, the terminal device determines a start position of the first duration based on a first time domain resource, wherein the first time domain resource is used for transmission of response information corresponding to the first configuration information. In some embodiments, the start position of the first duration is subsequent to a position of the first time domain resource, and a time distance between the start position of the first duration and the position of the first time domain resource is a first offset value.

In some embodiments, in the solutions shown in FIG. 10, the first configuration information includes at least one of a system message, an RRC, a MAC CE, or a DCI.

In summary, in the solutions according to the embodiments of the present disclosure, the network-side device transmits the first configuration information to the terminal device, such that the terminal device determines the first duration based on the first configuration information from the network-side device, and the first channel or signal is not transmitted between the terminal device and the network-side device within the first duration. In this way, the network-side device does not transmit or receive the first channel or signal within the first duration, such that the energy consumption of the network-side device is reduced, and network energy saving is achieved.

In addition, in some embodiments of the present disclosure, as the terminal device does not transmit the first channel or signal within the first duration in each first period neither, by the above solutions, the energy consumption of the terminal device is periodically reduced as well.

Referring to FIG. 11, a block diagram of an apparatus for wireless communication according to some embodiments of the present disclosure is shown. The apparatus may be configured in a terminal device. As shown in FIG. 11, the apparatus includes:
a receiving module 1101, configured to receive first configuration information from a network-side device; and
an acquiring module 1102, configured to acquire a first duration based on the first configuration information, wherein the first duration is not configured for transmission of a first channel or signal of a first cell.

In some embodiments, the first channel or signal includes a first downlink channel or signal, and the first duration being not configured for transmission of the first channel or signal of the first cell includes:
a first downlink resource in the first duration being not used for transmission of the first downlink channel or signal of the first cell.

The first downlink resource is a resource configured for transmission of the first downlink channel or signal.

In some embodiments, the first channel or signal includes the first downlink channel or signal, and an action of the terminal device includes at least one of:
performing no receive operation on the first downlink resource within the first duration;
not receiving the first downlink channel or signal on the first downlink resource within the first duration;
assuming that the network-side device does not transmit a downlink channel or signal on the first downlink resource within the first duration, or not expecting the network-side device to transmit a downlink channel or signal on the first downlink resource within the first duration; or
assuming that the network-side device does not transmit the first downlink channel or signal on the first downlink resource within the first duration, or not expecting the network-side device to transmit the first downlink channel or signal on the first downlink resource within the first duration.

In some embodiments, a downlink channel or signal included in the first downlink channel or signal is predefined; or
a downlink channel or signal included in the first downlink channel or signal is determined based on second configuration information of the network-side device.

In some embodiments, the first channel or signal includes a first uplink channel or signal, and the first duration being not configured for transmission of the first channel or signal of the first cell includes:
a first uplink resource within the first duration being not used for transmission of the first uplink channel or signal of the first cell.

The first uplink resource is a resource configured for transmission of the first uplink channel or signal.

In some embodiments, the first channel or signal includes the first uplink channel or signal, and the action of the terminal device includes at least one of:
performing no transmit operation on the first uplink resource within the first duration;
not transmitting the first uplink channel or signal on the first uplink resource within the first duration;
assuming that the network-side device does not receive an uplink channel or signal on the first uplink resource within the first duration, or not expecting the network-side device to receive an uplink channel or signal on the first uplink resource within the first duration; or
assuming that the network-side device does not receive the first uplink channel or signal on the first uplink resource within the first duration, or not expecting the network-side device to receive the first uplink channel or signal on the first uplink resource within the first duration.

In some embodiments, an uplink channel or signal included in the first uplink channel or signal is predefined.

Alternatively, an uplink channel or signal included in the first uplink channel or signal is determined based on third configuration information of the network-side device.

In some embodiments, whether the first duration is configured for transmission of the first channel or signal of the first cell is determined based on fourth configuration information of the network-side device.

In some embodiments, the fourth configuration information includes at least one of:
a first wake-up signal associated within the first duration;
a first PDCCH associated within the first duration;
a first system message associated within the first duration;
a first MAC CE message associated within the first duration; or
a first RRC message associated within the first duration.

In some embodiments, acquiring the first duration based on the first configuration information includes:
based on the first configuration information, acquiring at least one of:
a length of the first duration, a start subframe of the first duration, a start slot of the first duration, a start symbol of the first duration, an end position of the first duration, or the fourth configuration information associated within the first duration.

In some embodiments, the first configuration information is carried in at least one of:
a system message, a cell-common RRC message, a group-common RRC message, a terminal device-specific RRC message, a cell-common MAC CE message, a group-common MAC CE message, a terminal device-specific MAC CE message, a cell-common DCI message, a group-common DCI message, or a terminal device-specific DCI message.

In some embodiments, acquiring the first duration based on the first configuration information includes:
determining a start position of the first duration based on a first time domain resource, wherein the first time domain resource is used for transmission of response information corresponding to the first configuration information.

In some embodiments, acquiring the first duration based on the first configuration information includes:
acquiring a first period based on the first configuration information, wherein the first period corresponds to the first cell and the first period includes the first duration.

In some embodiments, the first period including the first duration includes:
the first duration being the first period; or
a start position of the first period being the same as a start position of the first duration; or
an end position of the first period being the same as an end position of the first duration; or
a start position of the first period being the same as a start position of the first duration, and an end position of the first period being the same as an end position of the first duration.

In some embodiments, the first period further includes a second duration, the second duration being configured for transmission of the first channel or signal of the first cell.

In some embodiments, the first channel or signal includes the first downlink channel or signal and/or the first uplink channel or signal.

The second duration being configured for transmission of the first channel or signal of the first cell includes at least one of:
a second downlink resource within the second duration being used for transmission of the first downlink channel or signal of the first cell; or
a second uplink resource within the second duration being used for transmission of the first uplink channel or signal of the first cell.

The second downlink resource is a resource configured for transmission of the first downlink channel or signal.

The second uplink resource is a resource configured for transmission of the first uplink channel or signal.

In some embodiments, the first channel or signal includes the first downlink channel or signal and/or the first uplink channel or signal, and the action of the terminal device includes at least one of:
monitoring or receiving the first downlink channel or signal on the second downlink resource within the second duration;
transmitting the first uplink channel or signal on the second uplink resource within the second duration;
transmitting the first uplink channel or signal on the second uplink resource within the second duration in the case that a transport block to be transmitted is present in the terminal device;
assuming that the network-side device is allowed to transmit the first downlink channel or signal on the second downlink resource within the second duration; or
assuming that the network-side device is allowed to receive the first uplink channel or signal on the second uplink resource within the second duration.

In some embodiments, whether the first period includes the second duration is determined based on fifth configuration information of the network-side device.

In some embodiments, the first configuration information includes configuration information for determining the first period.

In some embodiments, the first configuration information is used for determining at least one of:
a length of the first period, a start subframe of the first period, a start slot of the first period, a start symbol of the first period, a length of the first duration in the first period, a start subframe of the first duration in the first period, a start slot of the first duration in the first period, a start symbol of the first duration in the first period, an end position of the first duration in the first period, a length of the second duration in the first period, a start subframe of the second duration in the first period, a start slot of the second duration in the first period, a start symbol of the second duration in the first period, an end position of the second duration in the first period, or the fourth configuration information associated with the first period.

In some embodiments, the first period is a common period corresponding to the first cell.

The first cell includes a portion of activated cells of the terminal device or a portion of configured cells of the terminal device.

In some embodiments, the first period is a cell-common period; and the first period corresponds to at least one terminal, and the at least one terminal includes one of:
all terminals in the cell, all terminals in an RRC connected state in the cell, all terminals in an RRC idle state in the cell, all terminals in an RRC inactive state in the cell, or all terminals in the RRC idle state and the RRC inactive state in the cell.

In some embodiments, the first period is a group-common period; and the first period corresponds to at least one terminal, wherein the at least one terminal includes terminals in the same group.

The terminals in the same group correspond to the same group RNTI or group identifier.

In some embodiments, the first period is a first DRX period.

The first duration includes all or a portion of times in the first DRX period excluding an active time; and/or

The second duration includes the active time in the first DRX period.

In some embodiments, the active time in the first DRX period includes at least one of:
a DRX on duration, a time of the DRX in an active state, a time of DRX downlink retransmission, a time of DRX uplink retransmission, a time of DRX contention resolution, a wait time after a scheduling request is transmitted, or a time after an RAR is successfully received and before a PDCCH that indicates a newly transmitted C-RNTI scrambling code is received,

A random access preamble corresponding to the RAR is not a contention-based random access preamble.

In some embodiments, the acquiring module 1102 is further configured to acquire a second period based on sixth configuration information transmitted by the network-side device, wherein the second period corresponds to the first cell.

The second period includes a third duration and/or a fourth duration,

The third duration is not configured for transmission of a second channel or signal of the first cell; and the fourth duration is configured for transmission of the second channel or signal of the first cell.

In some embodiments, a fifth duration includes a portion of the first duration that is overlapped with the third duration in a time domain; and
the fifth duration is not configured for transmission of the first channel or signal of the first cell and is not configured for transmission of the second channel or signal of the first cell; or
the fifth duration is not configured for transmission of the first channel or signal of the first cell; or
the fifth duration is not configured for transmission of the second channel or signal of the first cell; or
the fifth duration is not configured for transmission of all the channels or signals of the first cell.

In some embodiments, a sixth duration includes a portion of the first duration that is overlapped with the fourth duration in a time domain; and
the sixth duration is not configured for transmission of the first channel or signal of the first cell and is not configured for transmission of the second channel or signal of the first cell; or
the sixth duration is not configured for transmission of the first channel or signal of the first cell; or
the sixth duration is not configured for transmission of the second channel or signal of the first cell; or
the sixth duration is not configured for transmission of all the channels or signals of the first cell.

In some embodiments, a seventh duration includes a portion of the second duration that is overlapped with the third duration in a time domain; and
the seventh duration is not configured for transmission of the first channel or signal of the first cell and is not configured for transmission of the second channel or signal of the first cell; or
the seventh duration is not configured for transmission of the first channel or signal of the first cell; or
the seventh duration is not configured for transmission of the second channel or signal of the first cell; or
the seventh duration is not configured for transmission of all the channels or signals of the first cell.

In some embodiments, an eighth duration includes a portion of the second duration that is overlapped with the fourth duration in a time domain; and
the eighth duration is configured for transmission of the first channel or signal of the first cell and is configured for transmission of the second channel or signal of the first cell; or
the eighth duration is configured for transmission of the first channel or signal of the first cell; or
the eighth duration is configured for transmission of the second channel or signal of the first cell; or
the eighth duration is configured for transmission of all the channels or signals of the first cell.

In some embodiments, the second period includes a terminal device-specific DRX period, and/or the second period includes a terminal device-specific DTX period.

In some embodiments, the second period is a second DRX period;
the third duration includes all or a portion of times in the second DRX period excluding an active time; and/or
the fourth duration includes the active time in the second DRX period.

In some embodiments, the first downlink channel or signal includes one of:
all downlink channels or signals;
a common downlink channel or signal, wherein the common downlink channel or signal includes: a cell-common downlink channel or signal and/or a group-common downlink channel or signal;
a common downlink channel or signal, and a configurably scheduled terminal device-specific downlink channel or signal;
a common downlink channel or signal, and a dynamically scheduled terminal device-specific downlink channel or signal;
a common downlink channel or signal, and a terminal device-specific downlink channel or signal, wherein the terminal device-specific downlink channel or signal includes: a configurably scheduled terminal device-specific downlink channel or signal, and the dynamically scheduled terminal device-specific downlink channel or signal;
a configurably scheduled terminal device-specific downlink channel or signal;
a dynamically scheduled terminal device-specific downlink channel or signal; or
a terminal device-specific downlink channel or signal.

In some embodiments, the first uplink channel or signal includes one of:
all uplink channels or signals;
a PRACH;
a PRACH, and a configurably scheduled terminal device-specific uplink channel or signal;
a PRACH, and other uplink channels or signals excluding an HARQ-ACK feedback, aperiodic CSI reporting, and an aperiodic SRS;
a configurably scheduled terminal device-specific uplink channel or signal; or
other uplink channels or signals excluding an HARQ-ACK feedback, aperiodic CSI reporting, and an aperiodic SRS.

In some embodiments, the second channel or signal includes a second downlink channel or signal, and the second downlink channel or signal includes one of:
a terminal device-specific downlink channel or signal, wherein the terminal device-specific downlink channel or signal includes: a configurably scheduled terminal device-specific downlink channel or signal, and a dynamically scheduled terminal device-specific downlink channel or signal;
a configurably scheduled terminal device-specific downlink channel or signal; or
a dynamically scheduled terminal device-specific downlink channel or signal.

In some embodiments, the second channel or signal includes a second uplink channel or signal, and the second uplink channel or signal includes one of:
a terminal device-specific uplink channel or signal, wherein the terminal device-specific uplink channel or signal includes: a configurably scheduled terminal device-specific uplink channel or signal, and a dynamically scheduled terminal device-specific uplink channel or signal;
a configurably scheduled terminal device-specific uplink channel or signal; or
a dynamically scheduled terminal device-specific uplink channel or signal.

Referring to FIG. 12, a block diagram of an apparatus for wireless communication according to some embodiments of the present disclosure is shown. The apparatus can be configured in a network-side device. As shown in FIG. 12, the apparatus includes:
a transmitting module 1201, configured to transmit first configuration information to a terminal device, wherein the first configuration information is used for the terminal device to acquire a first duration, wherein the first duration is not configured for transmission of a first channel or signal of a first cell.

In some embodiments, the first channel or signal includes a first downlink channel or signal, and the first duration being not configured for transmission of the first channel or signal of the first cell includes:
a first downlink resource within the first duration being not used for transmission of the first downlink channel or signal of the first cell.

The first downlink resource is a resource configured for transmission of the first downlink channel or signal.

In some embodiments, the first channel or signal includes the first downlink channel or signal, and an action of the network-side device includes at least one of:
assuming that the terminal device performs no receive operation on the first downlink resource within the first duration;
assuming that the terminal device does not receive the first downlink channel or signal on the first downlink resource within the first duration;
not transmitting a downlink channel or signal on the first downlink resource within the first duration; or
not transmitting the first downlink channel or signal on the first downlink resource within the first duration.

In some embodiments, a downlink channel or signal included in the first downlink channel or signal is predefined.

Alternatively, a downlink channel or signal included in the first downlink channel or signal is determined based on second configuration information of the network-side device.

In some embodiments, the first channel or signal includes a first uplink channel or signal, and the first duration being not configured for transmission of the first channel or signal of the first cell includes:
a first uplink resource within the first duration being not used for transmission of the first uplink channel or signal of the first cell.

The first uplink resource is a resource configured for transmission of the first uplink channel or signal.

In some embodiments, in the case that the first uplink resource within the first duration is not configured for transmission of the first uplink channel or signal of the first cell, the action of the network-side device includes at least one of:
assuming that the terminal device performs no transmit operation on the first uplink resource within the first duration;
assuming that the terminal device does not transmit the first uplink channel or signal on the first uplink resource within the first duration;
not receiving an uplink channel or signal on the first uplink resource within the first duration; or
not receiving the first uplink channel or signal on the first uplink resource within the first duration.

In some embodiments, an uplink channel or signal included in the first uplink channel or signal is predefined.

Alternatively, an uplink channel or signal included in the first uplink channel or signal is determined based on third configuration information of the network-side device.

In some embodiments, whether the first duration is configured for transmission of the first channel or signal of the first cell is determined based on fourth configuration information of the network-side device.

In some embodiments, the fourth configuration information includes at least one of:
a first wake-up signal associated within the first duration;
a first PDCCH associated within the first duration;
a first system message associated within the first duration;
a first MAC CE message associated within the first duration; or
a first RRC message associated within the first duration.

In some embodiments, the first configuration information is used for the terminal device to acquire at least one of:
a length of the first duration, a start subframe of the first duration, a start slot of the first duration, a start symbol of the first duration, an end position of the first duration, or the fourth configuration information associated within the first duration.

In some embodiments, the first configuration information is carried in at least one of:
a system message, a cell-common RRC message, a group-common RRC message, a terminal device-specific RRC message, a cell-common MAC CE message, a group-common MAC CE message, a terminal device-specific MAC CE message, a cell-common DCI message, a group-common DCI message, or a terminal device-specific DCI message.

In some embodiments, the first configuration information is used for the terminal device to determine a start position of the first duration based on a first time domain resource, wherein the first time domain resource is used for transmission of response information corresponding to the first configuration information.

In some embodiments, the first configuration information is used for the terminal device to acquire a first period based on the first configuration information, wherein the first period corresponds to the first cell and the first period includes the first duration.

In some embodiments, the first period including the first duration includes:
the first duration being the first period; or
a start position of the first period being the same as a start position of the first duration; or
an end position of the first period being the same as an end position of the first duration; or
a start position of the first period being the same as a start position of the first duration, and an end position of the first period being the same as an end position of the first duration.

In some embodiments, the first period further includes a second duration, the second duration being configured for transmission of the first channel or signal of the first cell.

In some embodiments, the first channel or signal includes the first downlink channel or signal and/or the first uplink channel or signal; and
the second duration being configured for transmission of the first channel or signal of the first cell includes at least one of the following:
a second downlink resource within the second duration being used for transmission of the first downlink channel or signal of the first cell; or
a second uplink resource within the second duration being used for transmission of the first uplink channel or signal of the first cell.

The second downlink resource is a resource configured for transmission of the first downlink channel or signal.

The second uplink resource is a resource configured for transmission of the first uplink channel or signal.

In some embodiments, the first channel or signal includes the first downlink channel or signal and/or the first uplink channel or signal, and the action of the network-side device includes at least one of:
assuming that the terminal device monitors or receives the first downlink channel or signal on the second downlink resource within the second duration;
assuming that the terminal device transmits the first uplink channel or signal on the second uplink resource within the second duration;
assuming that the terminal device transmits the first uplink channel or signal on the second uplink resource within the second duration in the case that a transport block to be transmitted is present in the terminal device;
being allowed to transmit the first downlink channel or signal on the second downlink resource within the second duration; or
being allowed to receive the first uplink channel or signal on the second uplink resource within the second duration.

In some embodiments, whether the first period includes the second duration is determined based on fifth configuration information of the network-side device.

In some embodiments, the first configuration information includes configuration information for determining the first period.

In some embodiments, the first configuration information is used for determining at least one of:
a length of the first period, a start subframe of the first period, a start slot of the first period, a start symbol of the first period, a length of the first duration in the first period, a start subframe of the first duration in the first period, a start slot of the first duration in the first period, a start symbol of the first duration in the first period, an end position of the first duration in the first period, a length of the second duration in the first period, a start subframe of the second duration in the first period, a start slot of the second duration in the first period, a start symbol of the second duration in the first period, an end position of the second duration in the first period, or the fourth configuration information associated with the first period.

In some embodiments, the first period is a common period corresponding to the first cell; and
the first cell includes a portion of activated cells of the terminal device or a portion of configured cells of the terminal device.

In some embodiments, the first period is a cell-common period; and the first period corresponds to at least one terminal, and the at least one terminal includes at least one of:
all terminals in the cell, all terminals in an RRC connected state in the cell, all terminals in an RRC idle state in the cell, all terminals in an RRC inactive state in the cell, or all terminals in the RRC idle state and the RRC inactive state in the cell.

In some embodiments, the first period is a group-common period; and the first period corresponds to at least one terminal, wherein the at least one terminal includes terminals in the same group.

The terminals in the same group correspond to the same group RNTI or group identifier.

In some embodiments, the first period is a first DRX period,
the first duration includes all or a portion of times in the first DRX period excluding an active time; and/or
the second duration includes the active time in the first DRX period.

In some embodiments, the active time in the first DRX period includes at least one of:
a DRX on duration, a time of the DRX in an active state, a time of DRX downlink retransmission, a time of DRX uplink retransmission, a time of DRX contention resolution, a wait time after a scheduling request is transmitted, or a time after an RAR is successfully received and before a PDCCH that indicates a newly transmitted C-RNTI scrambling code is received.

A random access preamble corresponding to the RAR is not a contention-based random access preamble.

In some embodiments, the transmitting module 1201 is further configured to transmit sixth configuration information to the terminal device, wherein the sixth configuration information is used for the terminal device to acquire a second period, wherein the second period corresponds to the first cell.

The second period includes a third duration and/or a fourth duration,

The third duration is not configured for transmission of a second channel or signal of the first cell; and the fourth duration is configured for transmission of the second channel or signal of the first cell.

In some embodiments, a fifth duration includes a portion of the first duration that is overlapped with the third duration in a time domain; and
the fifth duration is not configured for transmission of the first channel or signal of the first cell and is not configured for transmission of the second channel or signal of the first cell; or
the fifth duration is not configured for transmission of the first channel or signal of the first cell; or
the fifth duration is not configured for transmission of the second channel or signal of the first cell; or
the fifth duration is not configured for transmission of all the channels or signals of the first cell.

In some embodiments, a sixth duration includes a portion of the first duration that is overlapped with the fourth duration in a time domain; and
the sixth duration is not configured for transmission of the first channel or signal of the first cell and is not configured for transmission of the second channel or signal of the first cell; or
the sixth duration is not configured for transmission of the first channel or signal of the first cell; or
the sixth duration is not configured for transmission of the second channel or signal of the first cell; or
the sixth duration is not configured for transmission of all the channels or signals of the first cell.

In some embodiments, a seventh duration includes a portion of the second duration that is overlapped with the third duration in a time domain; and
the seventh duration is not configured for transmission of the first channel or signal of the first cell and is not configured for transmission of the second channel or signal of the first cell; or
the seventh duration is not configured for transmission of the first channel or signal of the first cell; or
the seventh duration is not configured for transmission of the second channel or signal of the first cell; or
the seventh duration is not configured for transmission of all the channels or signals of the first cell.

In some embodiments, an eighth duration includes a portion of the second duration that is overlapped with the fourth duration in a time domain; and
the eighth duration is configured for transmission of the first channel or signal of the first cell and is configured for transmission of the second channel or signal of the first cell; or
the eighth duration is configured for transmission of the first channel or signal of the first cell; or
the eighth duration is configured for transmission of the second channel or signal of the first cell; or
the eighth duration is configured for transmission of all the channels or signals of the first cell.

In some embodiments, the second period includes at least one of a terminal device-specific DRX period, and/or the second period includes a terminal device-specific DTX period.

In some embodiments, the second period is a second DRX period;
the third duration includes all or a portion of times in the second DRX period excluding an active time; and/or
the fourth duration includes the active time in the second DRX period.

In some embodiments, the first downlink channel or signal includes one of:
all downlink channels or signals;
a common downlink channel or signal, wherein the common downlink channel or signal includes: a cell-common downlink channel or signal and/or a group-common downlink channel or signal;
a common downlink channel or signal, and a configurably scheduled terminal device-specific downlink channel or signal;
a common downlink channel or signal, and a dynamically scheduled terminal device-specific downlink channel or signal;
a common downlink channel or signal, and a terminal device-specific downlink channel or signal, wherein the terminal device-specific downlink channel or signal includes: a configurably scheduled terminal device-specific downlink channel or signal, and a dynamically scheduled terminal device-specific downlink channel or signal;
a configurably scheduled terminal device-specific downlink channel or signal;
a dynamically scheduled terminal device-specific downlink channel or signal; or
a terminal device-specific downlink channel or signal.

In some embodiments, the first uplink channel or signal includes one of:
all uplink channels or signals;
a PRACH;
a PRACH, and a configurably scheduled terminal device-specific uplink channel or signal;
a PRACH, and other uplink channels or signals excluding an HARQ-ACK feedback, aperiodic CSI reporting, and an aperiodic SRS;
a configurably scheduled terminal device-specific uplink channel or signal; or
other uplink channels or signals excluding an HARQ-ACK feedback, aperiodic CSI reporting, and an aperiodic SRS.

In some embodiments, the second channel or signal includes a second downlink channel or signal, and the second downlink channel or signal includes one of:
a terminal device-specific downlink channel or signal, wherein the terminal device-specific downlink channel or signal includes: a configurably scheduled terminal device-specific downlink channel or signal, and a dynamically scheduled terminal device-specific downlink channel or signal;
a configurably scheduled terminal device-specific downlink channel or signal; or
a dynamically scheduled terminal device-specific downlink channel or signal.

In some embodiments, the second channel or signal includes a second uplink channel or signal, and the second uplink channel or signal includes one of:
a terminal device-specific uplink channel or signal, wherein the terminal device-specific uplink channel or signal includes: a configurably scheduled terminal device-specific uplink channel or signal, and a dynamically scheduled terminal device-specific uplink channel or signal;
a configurably scheduled terminal device-specific uplink channel or signal; or
a dynamically scheduled terminal device-specific uplink channel or signal.

It should be noted that, in the case that the apparatus according to the above embodiments implements the functions thereof, the division of the functional modules is merely exemplary. In practice, the above functions may be assigned to different functional modules according to actual needs, i.e., the internal structure of the device may be divided into different functional modules, such that all or a portion of the above functions are implemented.

Regarding the apparatus according to the above embodiments, the specific manner in which each module performs the operation has been described in detail in the embodiments related to the method and is described in detail herein.

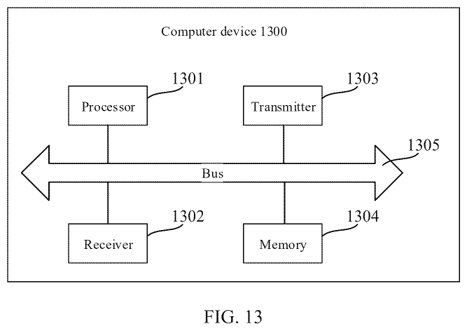

Referring to FIG. 13, a schematic structural diagram of a computer device 1300 according to some embodiments of the present disclosure is shown. The computer device 1300 includes: a processor 1301, a receiver 1302, a transmitter 1303, a memory 1304, and a bus 1305.

The processor 1301 includes one or more processing cores. The processor 1301 runs various functional applications and performs information processing by running software programs and modules.

The receiver 1302 and the transmitter 1303 may be implemented as a communication assembly, which may be a communication chip. The communication chip is also referred to as a transceiver.

The memory 1304 is connected to the processor 1301 via the bus 1305.

The memory 1304 is configured to store one or more computer programs, and the processor 1301 is configured to run the one or more computer programs to perform the processes performed by the terminal in the above method embodiments.

In addition, the memory 1304 is practiced by any type of volatile or non-volatile storage device or a combination thereof. The volatile or non-volatile storage device includes but is not limited to: a magnetic or optical disk, an electrically erasable programmable read-only memory, an erasable programmable read-only memory, a static random access memory, a read-only memory, a magnetic memory, a flash memory, or a programmable read-only memory.

The computer device may be implemented as the terminal device or the network-side device in the above method embodiments.

In some exemplary embodiments, the computer device includes a processor, a memory, and a transceiver (which may include a receiver for receiving information and a transmitter for transmitting information).

In the case that the above computer device is implemented as the terminal device in the above method embodiments, the transceiver is configured to receive first configuration information from a network-side device; and the processor is configured to acquire a first duration based on the first configuration information, wherein the first duration is not configured for transmission of a first channel or signal of a first cell.

For the processes performed by the transceiver and the processor, reference may be made to all or a portion of the processes performed by the terminal device in the embodiments shown in FIG. 4 or FIG. 7, which are not described herein any further.

In the case that the above computer device is implemented as the network-side device in the above method embodiments, the transceiver is configured to transmit first configuration information to a terminal device, wherein the first configuration information is used for the terminal device to acquire a first duration, wherein the first duration is not configured for transmission of a first channel or signal of a first cell.

For the processes performed by the transceiver and the processor, reference may be made to all or a portion of the processes performed by the network-side device in the embodiments shown in FIG. 5 or FIG. 7, which are not described herein any further.

The embodiments of the present disclosure further provide a computer-readable storage medium storing one or more computer programs. The one or more computer programs, when loaded and run by a processor, cause the processor to perform the processes performed by the terminal device or the network-side device in the method for wireless communication as shown in FIG. 4, FIG. 5, or FIG. 7.

The present disclosure further provides a computer program product or computer program. The computer program product or computer program includes one or more computer instructions stored in a computer-readable storage medium. The one or more computer instructions, when read from the computer-readable storage medium and executed by a processor of a computer device, cause the computer device to perform the processes performed by the terminal device or the network-side device in the method for wireless communication as shown in FIG. 4, FIG. 5, or FIG. 7.

The present disclosure further provides a computer program. The computer program includes one or more computer instructions stored in a computer-readable storage medium. The one or more computer instructions, when read from the computer-readable storage medium and executed by a processor of a computer device, cause the computer device to perform the processes performed by the terminal device or the network-side device in the method for wireless communication as shown in FIG. 4, FIG. 5, or FIG. 7.

The present disclosure further provides a chip applicable to a terminal. The chip is configured to perform the processes performed by the terminal device or the network-side device in the method for wireless communication as shown in FIG. 4, FIG. 5, or FIG. 7.

1. A method for wireless communication, applicable to a terminal device, the method comprising:
receiving first configuration information from a network-side device; and
acquiring a first duration based on the first configuration information, wherein the first duration is not configured for transmission of a first channel or signal of a first cell.

2. The method according to claim 1, wherein there is at least one of:
the first channel or signal comprises a first downlink channel or signal; and the first duration being not configured for transmission of the first channel or signal of the first cell comprises: a first downlink resource within the first duration being not used for transmission of the first downlink channel or signal of the first cell; wherein the first downlink resource is a resource configured for transmission of the first downlink channel or signal;
the first channel or signal comprises a first uplink channel or signal; and the first duration being not configured for transmission of the first channel or signal of the first cell comprises: a first uplink resource within the first duration being not used for transmission of the first uplink channel or signal of the first cell; wherein the first uplink resource is a resource configured for transmission of the first uplink channel or signal.

3. The method according to claim 1, wherein whether the first duration is configured for transmission of the first channel or signal of the first cell is determined based on fourth configuration information of the network-side device;
wherein the fourth configuration information comprises a first physical downlink control channel (PDCCH) associated within the first duration.

4. The method according to claim 1, wherein acquiring the first duration based on the first configuration information comprises:
acquiring a first period based on the first configuration information, wherein the first period corresponds to the first cell and the first period comprises the first duration;
wherein the first period further comprises a second duration, wherein the second duration being configured for transmission of the first channel or signal of the first cell.

5. The method according to claim 4, wherein:
the first channel or signal comprises at least one of a first downlink channel or signal or a first uplink channel or signal; and
the second duration being configured for transmission of the first channel or signal of the first cell comprises at least one of:
a second downlink resource within the second duration being used for transmission of the first downlink channel or signal of the first cell; or
a second uplink resource within the second duration being used for transmission of the first uplink channel or signal of the first cell;
wherein:
the second downlink resource is a resource configured for transmission of the first downlink channel or signal; and
the second uplink resource is a resource configured for transmission of the first uplink channel or signal.

6. The method according to claim 4, wherein the first configuration information comprises configuration information for determining the first period;
wherein the first configuration information is used for determining at least one of:
a length of the first period, a start subframe of the first period, a start slot of the first period, a start symbol of the first period, a length of the first duration in the first period, a start subframe of the first duration in the first period, a start slot of the first duration in the first period, a start symbol of the first duration in the first period, an end position of the first duration in the first period, a length of a second duration in the first period, a start subframe of a second duration in the first period, a start slot of a second duration in the first period, a start symbol of a second duration in the first period, an end position of a second duration in the first period, or fourth configuration information associated with the first period.

7. The method according to claim 4, further comprising:
acquiring a second period based on sixth configuration information from the network-side device, wherein the second period corresponds to the first cell, and the second period comprises at least one of a third duration or a fourth duration;
wherein the third duration is not configured for transmission of a second channel or signal of the first cell, and the fourth duration is configured for transmission of the second channel or signal of the first cell;
wherein the second period comprises at least one of a terminal device-specific discontinuous reception (DRX) period or a terminal device-specific discontinuous transmission (DTX) period.

8. The method according to claim 7, wherein a fifth duration comprises a portion of the first duration that is overlapped with the third duration in a time domain; wherein
the fifth duration is not configured for transmission of the first channel or signal of the first cell and is not configured for transmission of the second channel or signal of the first cell; or
the fifth duration is not configured for transmission of the first channel or signal of the first cell; or
the fifth duration is not configured for transmission of the second channel or signal of the first cell; or
the fifth duration is not configured for transmission of all the channels or signals of the first cell.

9. The method according to claim 7, wherein a sixth duration comprises a portion of the first duration that is overlapped with the fourth duration in a time domain; wherein
the sixth duration is not configured for transmission of the first channel or signal of the first cell and is not configured for transmission of the second channel or signal of the first cell; or
the sixth duration is not configured for transmission of the first channel or signal of the first cell; or
the sixth duration is not configured for transmission of the second channel or signal of the first cell; or
the sixth duration is not configured for transmission of all the channels or signals of the first cell.

10. The method according to claim 7, wherein a seventh duration comprises a portion of the second duration that is overlapped with the third duration in a time domain; wherein
the seventh duration is not configured for transmission of the first channel or signal of the first cell and is not configured for transmission of the second channel or signal of the first cell; or
the seventh duration is not configured for transmission of the first channel or signal of the first cell; or
the seventh duration is not configured for transmission of the second channel or signal of the first cell; or
the seventh duration is not configured for transmission of all the channels or signals of the first cell.

11. The method according to claim 7, wherein an eighth duration comprises a portion of the second duration that is overlapped with the fourth duration in a time domain; wherein
the eighth duration is configured for transmission of the first channel or signal of the first cell and is configured for transmission of the second channel or signal of the first cell; or
the eighth duration is configured for transmission of the first channel or signal of the first cell; or
the eighth duration is configured for transmission of the second channel or signal of the first cell; or
the eighth duration is configured for transmission of all the channels or signals of the first cell.

12. A terminal device, comprising:
a processor, a memory, and a transceiver, wherein the transceiver and the processor are configured to:
receive first configuration information from a network-side device; and
acquire a first duration based on the first configuration information, wherein the first duration is not configured for transmission of a first channel or signal of a first cell.

13. The terminal device according to claim 12, wherein there is at least one of:
the first channel or signal comprises a first downlink channel or signal; and the first duration being not configured for transmission of the first channel or signal of the first cell comprises: a first downlink resource within the first duration being not used for transmission of the first downlink channel or signal of the first cell; wherein the first downlink resource is a resource configured for transmission of the first downlink channel or signal;
the first channel or signal comprises a first uplink channel or signal; and the first duration being not configured for transmission of the first channel or signal of the first cell comprises: a first uplink resource within the first duration being not used for transmission of the first uplink channel or signal of the first cell; wherein the first uplink resource is a resource configured for transmission of the first uplink channel or signal.

14. The terminal device according to claim 13, wherein the first downlink channel or signal comprises one of:
all downlink channels or signals;
a common downlink channel or signal, wherein the common downlink channel or signal comprises at least one of a cell-common downlink channel or signal or a group-common downlink channel or signal;
a common downlink channel or signal, and a configurably scheduled terminal device-specific downlink channel or signal;
a common downlink channel or signal, and a dynamically scheduled terminal device-specific downlink channel or signal;
a common downlink channel or signal, and a terminal device-specific downlink channel or signal, wherein the terminal device-specific downlink channel or signal comprises: a configurably scheduled terminal device-specific downlink channel or signal, and a dynamically scheduled terminal device-specific downlink channel or signal;
a configurably scheduled terminal device-specific downlink channel or signal;
a dynamically scheduled terminal device-specific downlink channel or signal; or
a terminal device-specific downlink channel or signal.

15. The terminal device according to claim 13, wherein the first uplink channel or signal comprises one of:
all uplink channels or signals;
a physical random access channel (PRACH);
a PRACH, and a configurably scheduled terminal device-specific uplink channel or signal;
a PRACH, and other uplink channels or signals excluding a hybrid automatic repeat request-acknowledgment (HARQ-ACK) feedback, aperiodic channel state information (CSI) reporting, and an aperiodic sounding reference signal (SRS);
a configurably scheduled terminal device-specific uplink channel or signal; or
other uplink channels or signals excluding an HARQ-ACK feedback, aperiodic CSI reporting, and an aperiodic SRS.

16. A network-side device, comprising:
a processor, a memory, and a transceiver, wherein the transceiver is configured to:
transmit first configuration information to a terminal device, wherein the first configuration information is used for the terminal device to acquire a first duration, wherein the first duration is not configured for transmission of a first channel or signal of a first cell.

17. The network-side device according to claim 16, wherein there is at least one of:
the first channel or signal comprises a first downlink channel or signal; and the first duration being not configured for transmission of the first channel or signal of the first cell comprises: a first downlink resource within the first duration being not used for transmission of the first downlink channel or signal of the first cell; wherein the first downlink resource is a resource configured for transmission of the first downlink channel or signal; or
the first channel or signal comprises a first uplink channel or signal; and the first duration being not configured for transmission of the first channel or signal of the first cell comprises: a first uplink resource within the first duration being not used for transmission of the first uplink channel or signal of the first cell, wherein the first uplink resource is a resource configured for transmission of the first uplink channel or signal.

18. The network-side device according to claim 16, wherein whether the first duration is configured for transmission of the first channel or signal of the first cell is determined based on fourth configuration information of the network-side device;
wherein the fourth configuration information comprises a first physical downlink control channel (PDCCH) associated within the first duration.

19. The network-side device according to claim 16, wherein the first configuration information is used for the terminal device to acquire a first period based on the first configuration information, wherein the first period corresponds to the first cell and the first period comprises the first duration;
wherein the first period further comprises a second duration, wherein the second duration being configured for transmission of the first channel or signal of the first cell.

20. The network-side device according to claim 19, wherein:
the first channel or signal comprises at least one of a first downlink channel or signal or a first uplink channel or signal; and
the second duration being configured for transmission of the first channel or signal of the first cell comprises at least one of:
a second downlink resource within the second duration being used for transmission of the first downlink channel or signal of the first cell; or
a second uplink resource within the second duration being used for transmission of the first uplink channel or signal of the first cell;
wherein:
the second downlink resource is a resource configured for transmission of the first downlink channel or signal; and
the second uplink resource is a resource configured for transmission of the first uplink channel or signal.
